(19) United States
(12) Patent Application Publication
(10) Pub. No.: US 2010/0206869 A1
(43) Pub. Date: Aug. 19, 2010

(54) HEAT PUMP WATER HEATER CONTROL

(75) Inventors: Jonathan D. Nelson, Louisville, KY (US); John Kenneth Hooker, Louisville, KY (US); Arti Arvindbhai Shah, Maharashtra (IN); Andrew L. Reder, Louisville, KY (US); Eric K. Watson, Crestwood, KY (US); Irena Jozic McDowell, Louisville, KY (US); Almir Begovich, Louisville, KY (US); Jennifer Amy Floyd, Louisville, KY (US); Craig Lung-Pie Tsai, Louisville, KY (US); Jeffrey Alan Kern, Louisville, KY (US)

Correspondence Address: Alan G. Gorman;Merchant & Gould, L.L.C., Suite 4300, 191 Peachtree Street N.E., Atlanta, GA, 30303, US

(73) Assignee: GENERAL ELECTRIC COMPANY, SCHENECTADY, NY (US)

(21) Appl. No.: 12/371,571

(22) Filed: Feb. 13, 2009

(51) Int. Cl. H05B 1/02; F24H 1/18; G05B 15/00; G05D 23/00

(52) U.S. Cl. 219/494; 392/441; 700/275; 700/299

(57) ABSTRACT

Systems and methods for controlling a heat pump water heater (HPWH) are disclosed. The systems include an interface for accepting a user input and configured to indicate a mode of operation, and indicate at least one error condition when an error condition exists. The systems are operative to diagnose various failure conditions and as advise a user that maintenance may be needed and to adjust operation for varying environmental or other external conditions.

### RELATED APPLICATION

Related U.S. application Ser. No. ______, entitled “RESIDENTIAL HEAT PUMP WATER HEATER” (60280.0012US01), filed on even date herewith in the name of Nelson et al., assigned to the assignee of the present application, are also hereby incorporated by reference.

### FIELD OF INVENTION

Embodiments of the present invention relate to appliances. More specifically, embodiments of the present invention relate to systems and methods for controlling heat pump water heaters.

### BACKGROUND OF THE INVENTION

Currently, consumers have to bear a higher energy cost when using standard water heating methods (e.g. natural gas or only electric heaters). Current heat pump water heaters do not allow for mode programming. In addition, current heat pump water heaters do not have built in diagnostic features. Furthermore, current heat pump water heaters do not allow for automatic adjustment of the heat pump water heater depending on environmental conditions.

There exists a need for heat pump water heaters that have the ability to diagnose various problems as well as advise a user that maintenance may be needed. Furthermore, there exists a need for heat pump water heaters that may adjust operation for varying environmental conditions.

### BRIEF DESCRIPTION OF THE INVENTION

Consistent with embodiments of the present invention, systems for controlling a heat pump water heater (HPWH) are disclosed. The systems may include an interface for accepting a user input. The interface may be configured to indicate a HPWH mode of operation, and indicate at least one error condition when an error condition exists. The systems may further include temperature sensors configured to detect water temperature of the water in a storage tank. A controller coupled to the interface may be included for interpreting the user input and water temperature to control operation of the HPWH based on the mode of operation.

Still consistent with embodiments of the present invention, methods for controlling a heat pump water heater (HPWH) are disclosed. The methods may include 1) receiving a user input, 2) receiving a first temperature indication, and 3) interpreting a first temperature indication to activate or deactivate a sealed system (e.g. a heat pump) and activate or deactivate the at least one electric resistance heater based upon a mode of operation.

### BRIEF DESCRIPTION OF THE FIGURES

Non-limiting and non-exhaustive embodiments are described with reference to the following figures, wherein like reference numerals refer to like parts throughout the various views unless otherwise specified.

FIG. 1 depicts a heat pump water heater schematic consistent with embodiments of the invention;

FIG. 2 depicts a heat pump water heater wiring diagram consistent with embodiments of the invention;

FIG. 3 depicts a control block diagram consistent with embodiments of the invention;

FIG. 4A-4B illustrates a process flow of the demand side management module's automatic control of the heat pump water heater in response to energy demand information received from the utility company;

FIG. 5 depicts a heat pump water heater user interface consistent with embodiments of the invention;

FIG. 6 illustrates a process flow for controller detection of an empty water tank; and

FIG. 7A-7P illustrates an embodiment of process flow associated for controller performance of system diagnostics.

### GENERAL DESCRIPTION

Reference may be made throughout this specification to “one embodiment,” “an embodiment,” “embodiments,” “an aspect,” or “aspects” meaning that a particular described feature, structure, or characteristic may be included in at least one embodiment of the present invention. Thus, usage of such phrases may refer to more than just one embodiment or aspect. In addition, the described features, structures, or characteristics may be combined in any suitable manner in one or more embodiments or aspects. Moreover, reference to a single item may mean a single item or a plurality of items, just as reference to a plurality of items may mean a single item.

Embodiments of the present invention utilize a system and method for controlling a heat pump water heater that comprises a water storage tank, at least one electric resistance heater configured to heat water within the water storage tank, and a heat pump. The heat pump comprises a working fluid, a compressor, an evaporator and a condenser that is operatively configured and positioned to heat water within the storage tank. The system is comprised of an interface, at least one temperature sensor positioned and configured to sense the temperature of the water in the water storage tank, and a controller programmed to control the heat pump water heater. The system interface is operatively configured to accept user input and enable a user to select an operating mode from a plurality of user selectable operating modes. The system interface is further configured to display at least one error condition when an error condition exists. The controller may be programmed to receive user inputs and have the preset user selectable modes of operation. In addition, the controller is electrically coupled to the interface and to the temperature sensor and may be programmed to interpret various temperature and other inputs for use in controlling the heat pump water heater. Furthermore, the temperature and other inputs may be interpreted by the controller to diagnose when the heat pump water heater may need maintenance by user, may be malfunctioning and/or may need service.

### DETAILED DESCRIPTION

Various embodiments are described more fully below with reference to the accompanying drawings, which form a part hereof, and which show specific embodiments of the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Accordingly, the following detailed description is, therefore, not to be taken in a limiting sense.

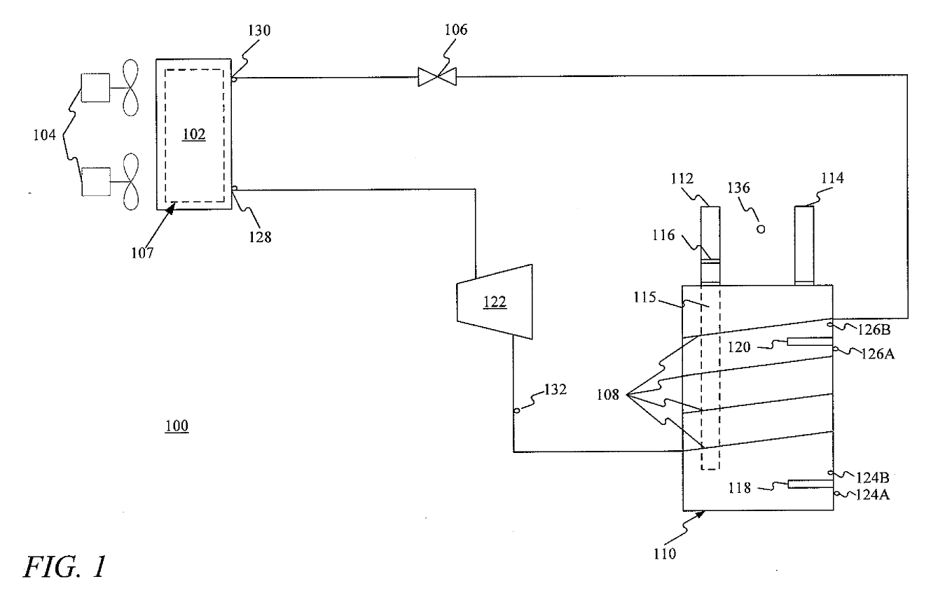

Referring now to the figures, FIG. 1 depicts a heat pump water heater 100 schematic consistent with embodiments of the invention. The sealed system of the heat pump system comprises an evaporator 102 equipped with an air filter 107, a compressor 122, a condenser 108 in heat exchange relationship with the hot water tank 110, a throttling device 106, and at least one fan 104. During operation of the heat pump cycle a refrigerant exits the evaporator 102 as a superheated vapor and/or high quality vapor mixture. Air filter 107 is located in proximity to the evaporator 102 so as to prevent dust/debris from building up on the evaporator 102, ultimately resulting in lower efficiency. Upon exiting the evaporator 102 the refrigerant enters the compressor 122 where the pressure and temperature increase. The temperature and pressure are increased in the compressor 122 such that the refrigerant becomes a superheated vapor. The superheated vapor from the compressor 122 enters the condenser 108. While in the condenser 108, the superheated vapor transfers energy to the water within a storage tank 110. Upon transferring energy to the water within the storage tank 110, the refrigerant turns into a saturated liquid and/or high quality liquid mixture. This high quality/saturated liquid mixture exits the condenser 108 and travels through the throttling device 106. Upon exiting the throttling device 106 the pressure and temperature of the refrigerant drop at which time the refrigerant enters evaporator 102 and the cycle repeats itself.

Upper and lower electric heating elements 118 and 120 are provided to heat the water in the tank in addition to the sealed system. Heating elements may be selectively used to supplement the sealed system depending on the operating needs of the system, such as for example when environmental conditions are not conducive to efficient heat pump operation, or when demand requires heating the water more rapidly than can be efficiently accomplished by use of the heat pump sealed system alone.

The heat pump water heater 100 may have temperature sensors placed at various locations. For example, a thermistor may be placed on tank 110 near upper heating element 120 as indicated by reference numeral 126A. A thermistor may also be placed on tank 110 near lower heating element 118 as indicated by reference numeral 124A. Alternatively, sensors may be positioned inside the tank as indicated by reference numerals 124B, 126B, and in direct contact with water located near the heating elements as illustrated. A thermistor may also be placed at the outlet of the compressor 122 as indicated by reference numeral 132. While the embodiment of FIG. 1 shows an upper and a lower temperature sensor for the tank, satisfactory performance has been demonstrated using only the upper temperature sensor 126, thereby avoiding the cost and additional complexity associated with the second sensor 124. A thermistor 136 may measure ambient temperature proximate the sealed system. Additionally, thermistors may measure the evaporator 102 inlet and exit temperatures as indicated by reference numerals 130 and 128, respectively.

The heat pump water heater 100 may include an inlet 112 for allowing cold water to enter the heat pump water heater 100, where it is directed to the bottom of the tank 110 via a dip tube 115. The heated water may then exit the heat pump water heater near top of tank 110 at exit 114 and flow to the residence or other place where heated water is desired. The heat pump water heater 100 may also include a flow meter 116 for measuring the amount and the flow rate of water into the heat pump water heater 100. The flow meter 116 may measure the total amount of water that has flowed into the heat pump water heater 100 during a given time interval. For example, the flow meter 116 may determine that in a given month a homeowner may have used 1,000 gallons of heated water.

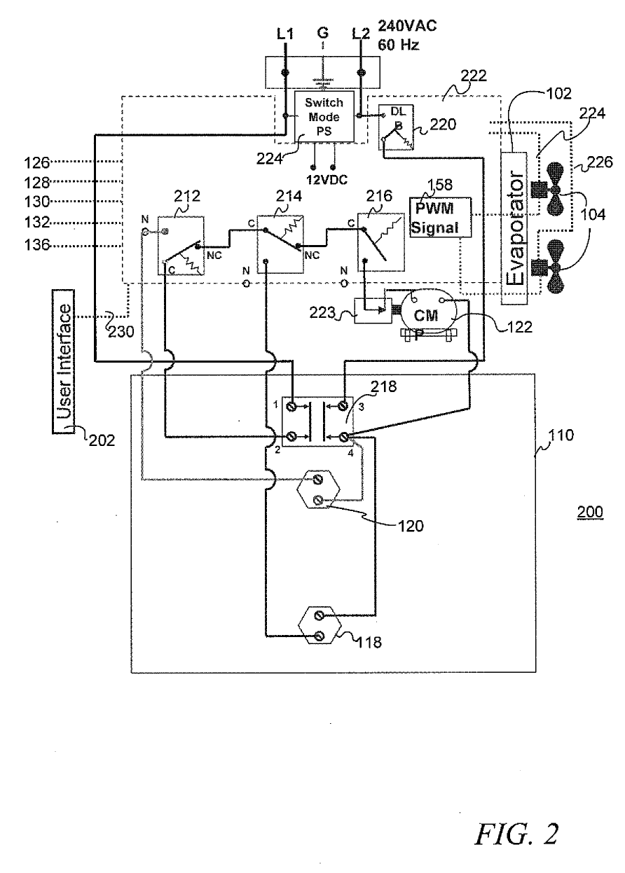

FIG. 2 is a representative wiring diagram for the illustrative embodiment of FIG. 1, but using only a single tank temperature sensor, upper sensor 126. The power input for the heat pump water heater 100 may be standard residential power. For example, the power supply may be a 240 volt alternating current (VAC) circuit operating at 60 Hz. This generally consists of three wires; two 120 VAC inputs and one ground, (i.e. no neutral wire). A Switch Mode Power Supply 225 is provided in the form of a conventional rectification circuit to provide a regulated 12 volt dc power supply for the fans 104 and for the relay drivers and other electronic controller needs. System operation is controlled by a main controller 222. The main controller 222 receives inputs from temperature sensors 126, 128, 130, 132 and 136. In addition, the main controller 222 receives feedback inputs from and controls operation of the fans 104 as indicated by reference numerals 224 and 226 and may accept other inputs such as from a flow meter, not shown in FIG. 2.

In the illustrative embodiment, fans 104 are variable speed dc fans. However, ac fans could be similarly employed. Operation of the fans 104 includes monitoring and controlling fan speed, and providing power to the fans 104 for operation by way of pulse width modulated pulses from signal generator 158. In one embodiment, fan speed is monitored via tachometer feedback built into the fan. The fans utilized in the present embodiment may be of a magnet/hall-effect sensor design. When a fan rotates, the magnet passes near the hall-effect sensor resulting in a pulse signal output. The frequency of the pulses generated is analyzed and used to calculate the rotational speed of the fan. Notwithstanding the specific method of monitoring fan speed in the above described embodiment, it is contemplated that fan speed may be monitored in plurality many different ways. The main controller 222 may also be configured to recognize a fan malfunction such as burnt out motors, excess winding temperatures, vibration, inadequate fan speed, etc. Using the above described tachometer feedback; the signal sent to the fan may be compared with the speed feedback to diagnose a fan failure as will be hereinafter described.

The main controller 222 also includes a relay 212 for controlling the upper heating element 120, a relay 214 for controlling the lower heating element 118, and a relay 216 for controlling the compressor 122. Relays 212-216 are cascaded such that only one of the heat sources is energized at any one time. The cascaded relays are coupled to power supply line L1 through contacts 1 and 2 of thermal cutout switch 218. Similarly, the power circuit is coupled to power supply line L2 through contacts 3 and 4 of switch 218. Switch 218 is a convention thermal cut out switch which is mounted to the wall of tank 110 to be responsive to the temperature of the tank wall. If the tank wall overheats to a temperature in excess of the cut out threshold temperature, which in the illustrative embodiment is 170_degrees F., the switch element coupling contact 1 to contact 2 opens breaking the connection to L1 and the switch element coupling contacts 3 and 4 opens breaking the connection to L2, thereby limiting the temperature of the tank. Relay 220 couples contact 3 of cut out switch 218 to L2, to provide a double break between the AC power supply and the power control circuitry when the system is in the off state. Controller 222 switches relay 220 to couple L2 to contact 3 of switch 218, when the system is on and relay 220 is in its normally open state otherwise. Referring again to the cascaded arrangement of relays 212-216, terminal c of relay 212 is connected to contact 2 of switch 218. Its normally open contact is connected to upper heating element 120, and its normally closed contact is connected to terminal c of relay 214. The normally open contact of relay 214 is connected to lower heating element 118 and its normally closed contact is connected to terminal c of relay 216. The normally open contact of relay 216 is connected to compressor 122 through discharge pressure cutoff switch 222. Cutoff switch 222 is a conventional pressure switch employed in a conventional manner to protect the sealed system from excessive pressure. By this arrangement to energize upper element 120, controller 222 switches relay 212 to its normally open state thereby connecting heating element 120 across L1 and L2. When relay 212 is in this state, L1 can only be connected to heating element 120. To energize lower heating element 118, controller 222 switches relay 212 to its normally closed state and relay 214 to its normally open state. This connects heating element 118 across L1 and L2. When relay 212 is in its normally closed state and relay 214 is in its normally open state L1 can only be connected to lower element 118. To energize compressor 122, controller 222 switches relays 212 and 214 to their normally closed states and switches relay 216 to its normally open state. This connects pressure switch 222 and compressor 122 in series across L1 and L2. The main controller 222 also accepts inputs from a user interface 202 as indicated by reference numeral 230. The main controller 152 also may include an integral timer that is configured as part of the heat pump water heater electronic control, providing a user with the ability to control and program the heating activity of the heat pump water heater, such that energy may be conserved when there is no need for water to be heated.

In the circuit configuration for the embodiment illustrated in FIG. 2, during operation of the heat pump water heater 100 only one of heat sources, that is, heating elements 120 and 118 and compressor 122 may operate at any given time. This limits the electrical load. However, it is contemplated that in alternative configurations, that one of heating elements 120 or 118 and the compressor 122 may operate simultaneously. Furthermore, it is contemplated that in alternative configurations both heating elements 120 and 118 and the compressor 122 may operate simultaneously. However, operation of both heating elements 120 and 118 at the same time may require special electrical considerations (e.g. a larger circuit breaker, a dedicated circuit, etc.) to accommodate an increased current draw. Notwithstanding, it is contemplated that operation of both heating elements 120 and 118 may occur at the same time.

The main controller 222 may also track water usage patterns. By tracking water usage pattern, the heat pump water heater 100 may automatically adjust operating modes or set point temperatures or both during certain periods to accommodate predicted demands. For example, the heat pump water heater 100 may track water usage for a month and determine that between the hours of 6 AM and 7 AM on Monday through Friday the demand for hot water increases (i.e. a family is showering before work or school). During this time period the heat pump water heater may utilize heating elements 118 and 120 to shorten recovery time. Additional adjustments may include altering the set point from the hours of 1 AM and 5 AM because the main controller 222 has tracked that there is little or no demand for hot water during those hours. By tracking water usage, the heat pump water heater 100 may be able to supply hot water more efficiently and more cost effectively.

The main controller 222 also may include an integral timer that is configured as part of the heat pump water heater electronic control, providing a user with the ability to control and program the heating activity of the heat pump water heater, such that energy may be conserved when there is no need for water to be heated. In one embodiment, the controller 222 is located proximate the water storage tank 110 and the user interface 202 is located a substantial distance from the water storage tank 110. It is also contemplated that the controller 222 and the user interface 202 may both be located proximate the water storage tank. In the alternative, both the controller 222 and the user interface 202 may both be located a substantial distance from the water storage tank 110.

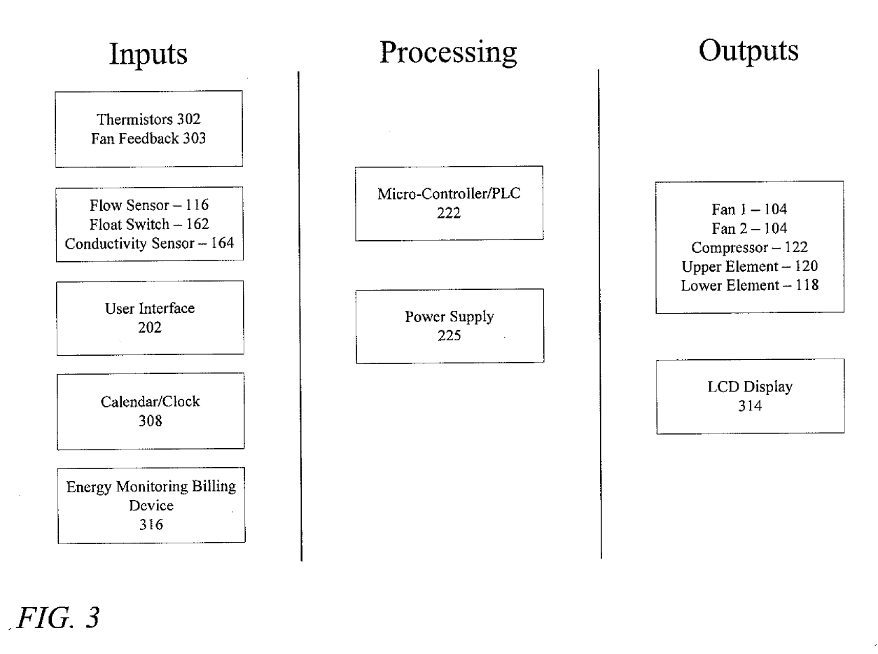

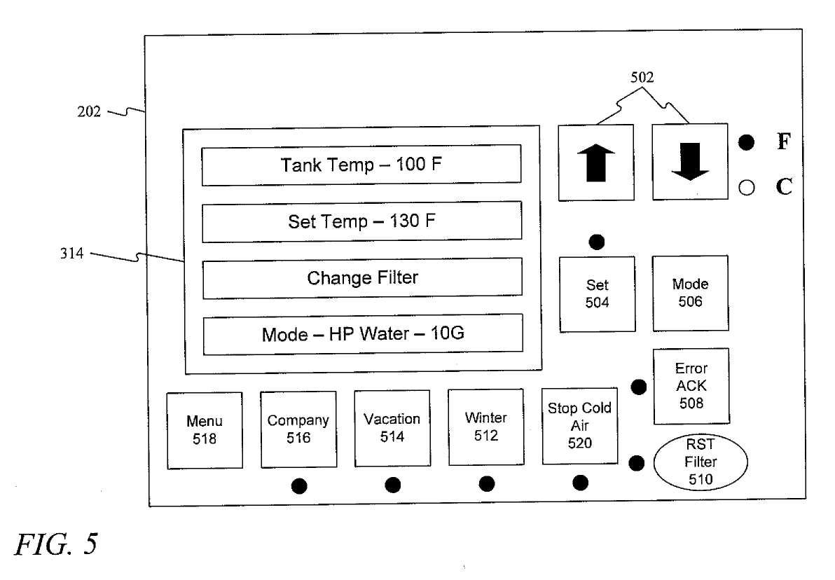

Referring now to FIG. 3, FIG. 3 depicts a control block diagram consistent with embodiments of the invention. The control block diagram indicates some of the inputs, processing, and outputs that may be required during operation of the heat pump water heater 100. For example, the inputs may include inputs from one or more temperature sensors, depending on the particular embodiment, collectively represented here as the temperature sensors 302. In the illustrative embodiments, the temperature sensors are thermistors, however, other types of temperature sensors could be similarly employed. Other inputs may include feedback 303 from the fans 104 indicative of fan speed. Also, inputs may be received from a flow sensor 116, a float switch 162, and a conductivity sensor 164. Flow sensor 116 could be used to monitor hot water usage. Float switch 162 may be used to monitor the accumulation of condensation from the evaporator and to cause a pump or other device to be activated to remove the condensation or to provide a signal to the user that condensate needs to be removed. Conductivity sensor 164 may be used for monitoring condensate accumulation in lieu of a float switch, or may be used to detect water near the base of the water heater indicating a potential leak in the water storage tank. The inputs may further comprise inputs from the user interface 202. User interface 202 will be discussed in more detail with reference to FIG. 5. Other inputs may also include a clock and/or a calendar 308. In one embodiment, the clock is powered by non-volatile memory/battery/capacitor in order to maintain time-of-day clock such that if power is lost, a user does not have to re-set the date/time (as is required on many household appliances with clocks). This may also be accomplished by more elegant methods of reading the atomic clock satellite output, etc. Inputs may also be received from an energy monitoring billing device 316. Energy monitor billing devices comprise devices installed by a utility company used to limit the power draw during peak demand times. For example, during summer months it is common for power companies to provide consumers with rebates for the privilege of allowing the power company to shut down devices which draw large amounts of power such as water heaters, heat pumps, and air conditioning systems.

The processing is done by the main controller 222. The main controller 222 includes a microprocessor for memory and data processing. The main controller 222 may also include a regulated power supply (225 in FIG. 2).

The outputs for the control system control power supply to fans 104, power to the compressor 122, upper heating element 120, and lower heating element 118. The outputs may also include information for display on user interface 202 (not shown), which may be in the form of an LCD display and or LED lights as indicated by reference numeral 314.

The ability to communicate with utilities allows a utility to shed load in an intelligent way without totally disabling the heat pump water heater 100. For example, utility could temporarily lower the set point, or put the heat pump water heater 100 into an energy saver mode. The communication may be done via a number of methods such as power line carrier, radio signal, paging or cellular technology. The heat pump water heater could also be connected to the internet. Internet communication may also allow the user and utility company to control the heat pump water heater from remote locations.

Energy monitor billing devices used by utilities are configured to output a signal indicating an electric rate at a given instant in time. For example, one embodiment of the energy monitor billing devices used by utilities are configured to output four signals, low, medium, high and critical Each signal corresponds to levels of energy demand. The output of a low signal occurs during a period when energy demand is low. The output of a critical signal occurs during a peak energy demand period. The output of medium and high signals is representative of energy demands somewhere between the low and peak periods. During low demand periods, the electric rate will be low. During peak demand periods, the electric rate will be highest. The controller 222 is further configured to receive and respond to the output signals transmitted by energy billing devices.

The processing is done by the main controller 222. The main controller 222 includes a microprocessor for memory and data processing. The main controller 222 may also include a regulated power supply (225 in FIG. 2).

The outputs for the control system control power supply to fans 104, power to the compressor 122, upper heating element 120, and lower heating element 118. The outputs may also include information for display on user interface 202 (not shown), which may be in the form of an LCD display and or LED lights as indicated by reference numeral 314.

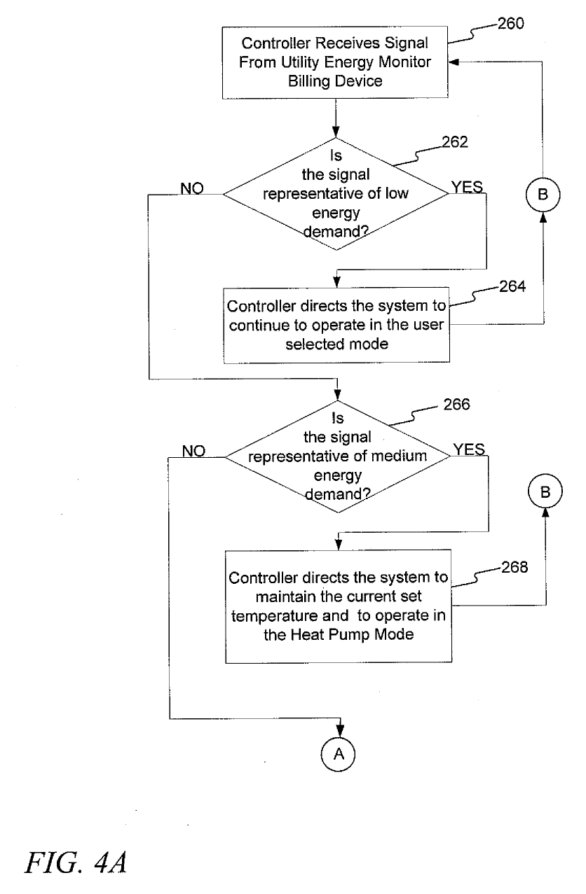

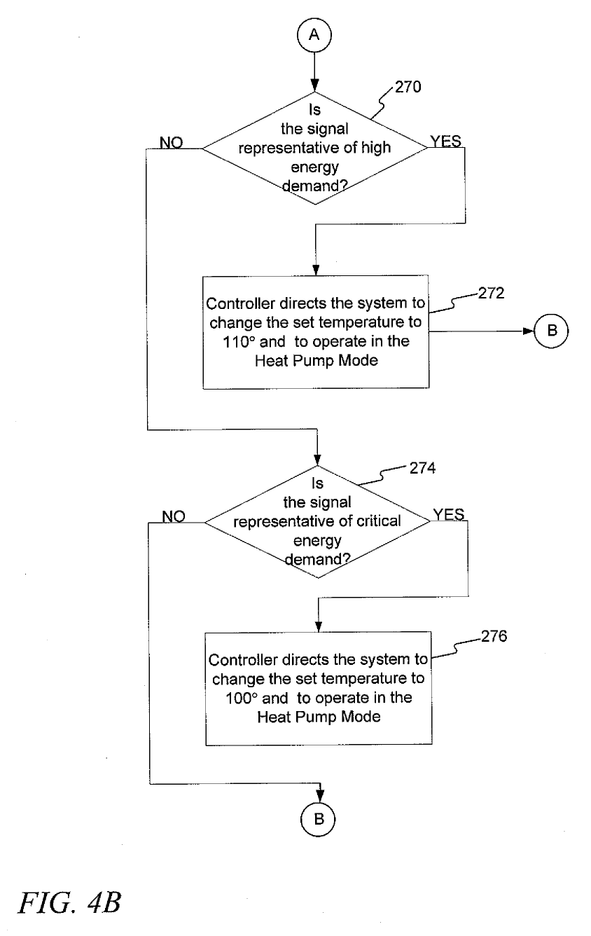

FIGS. 4A and 4B illustrate how controller 222 may process the inputs from the Energy Monitoring Billing Device (EMBD) 316 for efficient operation of the water heater. During system operation, controller 222 continuously receives a signal from EMBD 316 representative of energy demand at a given instant and operatively manages the mode of operation and set point temperatures for the water heater. As illustrated, the controller 222 receives a signal from an energy billing device 260. When the controller 222 determines that the signal received indicates that energy demand is low 262, or the EMBD is not functioning, the controller 222 will operate normally in accordance with user and sensor inputs received. Receipt of a signal indicated that energy demand is low causes the controller 222 to direct the system to continue to operate in the mode previously selected by the user (standard electric, heat pump, hybrid, and energy saver) and to remain in that mode until alternative instructions are provided by the controller in response to signals received from an energy billing device.

Alternatively, if the controller determines that the signal received indicates that energy demand is not low 262, the controller determines whether the signal received indicates that energy demand is medium 266. Upon a determination that energy demand is medium 266, the controller directs the system to operate in the heat pump mode regardless of the then current operating mode and to continue operating at the set temperature previously set by the user.

In heat pump mode, all start and run conditions for the sealed system will be applicable. If the sealed system is not available for any reason (for example, ambient temperature out of range, failed component, etc.), the controller 222 will switch to another available mode per the decision tree and remain in this mode until alternative instructions are provided by the controller in response to signals received from the EMBD.

Alternatively, if the controller determines that the signal received indicates that energy demand is not medium 266, the controller determines whether the signal received indicates that energy demand is high 270. Upon a determination that energy demand is high 270, the controller directs the system operate in the heat pump mode and to change its set temperature to 110 degrees Fahrenheit.

In heat pump mode, all start and run conditions for the sealed system will be applicable. If the sealed system is not available for any reason (for example, ambient temperature out of range, failed component, etc.), the controller 222 will switch to standard electric mode and remain in this mode until alternative instructions are provided by the controller in response to signals received from an energy billing device. If the controller determines that the signal received indicates that energy demand is not high 270, the controller determines whether the signal received indicates that energy demand is critical 274. Upon a determination that energy demand is critical 274, the controller directs the system to operate in the heat pump mode and to change its set temperature to 100 degrees Fahrenheit.

In heat pump mode, all start and run conditions for the sealed system will be applicable. If the sealed system is not available for any reason (for example, ambient temperature out of range, failed component, etc.), the controller 22 will switch to standard electric mode and remain in this mode until alternative instructions are provided by the controller in response to signals received from an energy billing device.

User interface 202 enables the user to select from a plurality of operating modes including a hybrid mode, a heat pump only mode, a standard electric mode, and a high demand mode, and also to select a set point temperature for the water in the tank. The set point temperature allows the user to set the heated water temperature. For example, the user may wish to have the water heated to 130° F. The set point temperature may also include a set point limiter which would prevent a consumer from setting the temperature too high. For example, in an attempt to prevent supplying undesirably high temperature water, the consumer set point selection may be limited to not greater than 150° F.

Note that for the sealed system to operate properly, certain sealed system conditions must be satisfied. Controller 222 includes a timer for monitoring sealed system off times. The off time may be tracked and used to diagnose a malfunction and prohibit the sealed system from operating in an undesirable manner. For example, the off time of the compressor 122 may be tracked to prevent short cycling. In other words, the compressor 122 may be forced to stay off for a minimum period between on cycles to allow for sealed system recovery (e.g. 3 minutes, etc.).

Other sealed system conditions may involve the evaporator temperature relative to a set-point temperature. For example, a condition requiring the evaporator temperature to be above a certain set point may be utilized to shut down the sealed system should the evaporator 102 “freeze up.” In addition, the evaporator inlet and exit temperatures may be monitored and used to help determine when the refrigerant charge may be low. Another sealed system condition may include monitoring the compressor temperature. The compressor 122 exceeding a certain temperature may indicate a malfunctioning sealed system, thus requiring maintenance. In one embodiment, when the compressor discharge temperature is greater than the pre-determined threshold temperature of 240° F., the system automatically switches from heat pump mode to standard electric mode.

Heat pump water heaters may be installed in close proximity to living spaces. For example, in some homes, the water heater may be installed in a hall closet. Heat pump water heaters extract energy from surroundings and transfer that energy to the water in the storage tank. For instances when the heat pump water heater 100 is installed near living spaces care must be taken so the air temperature of the surroundings does not decrease too quickly or below a certain temperature. To address this concern, controller 222 may monitor the ambient temperature and if it drops below a certain set point or drops by a given amount over a set time period the controller shuts the sealed system down. Because the heat pump loses the ability to transfer heat efficiently when the ambient temperature drops below a set point or drops by a defined amount over a set period of time, the functionality of the controller 222 shutting down the heat pump facilitates effective heat pump operation. For example, during operation of the heat pump water heater 100 if the ambient temperature drops below 45 degrees, the controller de-energizes the sealed system compressor and energizes one or both of heating elements 118 and 120 to heat the water.

Referring now to FIG. 5, FIG. 5 depicts the heat pump water heater 100 user interface 202 consistent with embodiments of the invention. The user interface 202 includes an LCD display 314 configured to display system information to the user. The user interface 202 also includes input pads 502 for allowing the user to set desired temperatures, indicate whether temperatures should be displayed in Fahrenheit or Celsius, toggle between display settings, etc.

The user interface 202 also includes mode selection keys as indicated by reference numerals 504 and 506. For example, to change the display screen the user presses the mode key 506 a given number of times to arrive at a desired menu. Upon reaching the desired menu, the user may cycle between selections using the input pads 502. Upon reaching the desired selection the user may select a setting using the set key 504. The menu button 518 allows the user to cycle the LCD display 314 to view various diagnostic and/or system performance data. Furthermore, it is contemplated that the LCD display 314 may be a touch screen display.

The user interface 202 includes an error acknowledgement key 508. The error acknowledgement key 508 allows the user to acknowledge that there is an error with operation of the water heater and allow the water heater to continue operation at a reduced efficiency and/or capacity. For example, based on the temperature differential across the evaporator 102, the user interface 202 may indicate that the sealed system may be low on refrigerant and shut down the sealed system. The user may acknowledge the error by pressing the error acknowledgement key 508. This allows the control to automatically transition into STD Electric mode so hot water is still available while waiting for service to occur.

It is contemplated that upon utilizing the error acknowledgement key 508, the user may be presented with a menu on the LCD display 314. The input pads 502 may allow the user to select a capacity at which the sealed system will operate. For example, the user may use the input pads 502 to indicate that the sealed system should only be used to heat the water to a set temperature and then the heating elements 118 and 120 may be used to heat the water to the desired set point Continuing on with this example, the sealed system may heat the water to 100° F. and then the heating elements 118 and 120 may heat the water from 100° F. to 145° F.

The user interface 202 includes a reset filter button 510. The reset filter button 510 includes an LED indicator to indicate when an evaporator air filter or water filter needs changing/cleaning. Changing the air filters may be necessary to prevent limiting the air flow over the evaporator which could result in frost build-up on the evaporator or otherwise decrease performance. The reset filter button 510 may be pressed by the user to indicate to the heat pump water heater 100 that the filter has been changed and to resume operation.

Aspects of the invention may also include mode selections. For example, the user may select in addition to the aforementioned operating modes, by selecting the company mode 516, vacation mode 514, and winter mode 512 keys. Pressing any of the mode keys initiates a preset mode which upon activation operates for a specific time period. After “timing out” preset modes may revert to a standard default operation. For example, the company mode 516 provides a useful mode for when the user has company visiting and therefore would have an increased demand for hot water. During high demand, the recovery time may need to be shortened. Therefore, in the Company mode, the heat pump water heater 100 utilizes the heating elements 118 and 120 to heat water vs. the sealed system.

The Vacation or Away mode 514 provides a useful mode for when the user expects to be out of town for a predetermined time period selected by the user (e.g. a week, two weeks, etc.). During this time the demand for hot water may be extremely low, therefore in this mode the controller lowers the set point to temperature to a lower than usual set point temperature, such as, for example, 50° F. and only allows activation of the heating elements 118 and 120 when the sealed system conditions are not favorable, such as ambient temperature too low. After the predetermined time has elapsed, the heat pump water heater 100 may return back to its prior mode or to a normal default mode. It is contemplated that the heat pump water heater may return to its prior mode at some predetermined time prior to the elapse of the user selected time period to allow the water heater to be at ready for normal use when the user selected time has elapsed. Winter mode 512 is a variation of the Vacation or Away mode 514 and may be used for extended periods of time such as, for example, the winter months.

The Stop Cold Air mode 520 is configured to enable the user to avoid being chilled by the cold air being output by the heat pump water heater as may be experienced when the system is using sealed system operating as a heat pump to heat the water. Upon activation of the Stop Cold Air mode 520, the heat pump water heater is switched into electric only mode and operates essentially as a regular electric water heater for a period of time.

It is contemplated that other modes of heat pump operation may be preprogrammed or the user may program custom modes. In the illustrative embodiments, the hybrid mode is the default mode of operation. In this mode the heat pump water heater operation may cycle between operating the sealed system and the heating elements 118 and 120 to heat water depending on the current demand for hot water. A standard electric mode can be selected manually. The standard electric mode consists of operating the heat pump water heater as an electric water heater (i.e. only operating using heating elements 118 and 120) with no use of the sealed system. An energy saver or heat pump only mode consists of operating the heat pump water heater 100 using only the sealed system (i.e. never using the heating elements 118 and 120) to heat water.

The user interface 314 also displays error conditions. For example, heat pump errors may be generated when, in spite of the heat pump operation mode selected, the compressor 122 does not function or is unable to operate properly. Another example of an error condition may be a sensor error. A sensor error may consist of a thermistor showing an out-of-range value. The out-of-range value may indicate a short or some other error condition which prohibits the thermistor from reporting temperatures correctly. An electric heater error may indicate that the heating element may have burnt out, there may be some type of short within the heating elements 118 and 120, or it may not be allowed to heat to an acceptable temperature level, etc

The ability to diagnose problems and implement diagnostics programs may reduce the number of service calls a consumer may have to make and may allow the consumer to evaluate functionality by checking various display modes. In addition, advance diagnostic function may allow for more focused diagnostics by a technician, allow the consumer to determine the type of technician may be needed. For example, a plumber or conventional water heater servicer may be needed for a problem with the heating elements or storage tank 110 that is those components typically associated with conventional electric water heaters, whereas a heating and air conditioner repair-person may be needed to repair a problem with the sealed system. To assist in determining which type of technician is needed, problems of the first type are herein categorized as water system failures. Problems involving the sealed system are categorized as heat pump failures. In addition, other diagnostic functions may include a configuration that facilitates the ability to detect the conditions under which the compressor 122 is unable to start or is not operating properly. The system may detect that the compressor 122 is unable to start due to high torque caused by high un-equalized pressure. In such a scenario, the controller sends a signal to the compressor, but the discharge temperature does not increase, or current flow is not detected (determining whether a relay within the circuit is closed). If the system detects that the discharge temperature does not increase, and that the relay did in fact close, but the compressor 122 did not start, then the system concludes that the compressor 122 did not start due to high un-equalized pressure condition.

Other diagnostic features may be the ability to detect a leak in the sealed system or a damaged valve in the compressor 122. Such a determination may be made when the compressor 122 starts but the discharge temperature does not increase. This may be detected with a temperature sensor 132. In an alternative embodiment, the system is configured to include pressure transducers (not shown) on the high side pressure and the low side pressure of the system. With respect to the transducer on the high side pressure of the system, the transducer is configured to detect whether the pressure is below a limit. If a determination is made that the pressure is below the limit on the high side, a leak in the sealed system is signified. In addition, the transducer on the high side pressure may assist in determining whether the high-side pressure is ramping too quickly or is too high, which indicates that there is no water in tank or restriction in the sealed system.

With respect to the transducer on the low pressure side of the system, the transducer is configured to detect whether the pressure is below a limit. If a determination is made that the pressure is below the limit on the low side, an error condition is signified which may be a closed/locked/plugged throttling device or moisture in the refrigerant, or a leak in the sealed system. The system is also configured with dry fire prevention diagnostic. Electric resistance heating elements 118, 120 will fail quickly if energized in air. To prevent this, when powering the unit, the compressor 122 must be energized first, and tank temperature sensors monitored to determine if water is present in tank. If the tank is empty, the temperature will ramp much more quickly than it would if water is present.

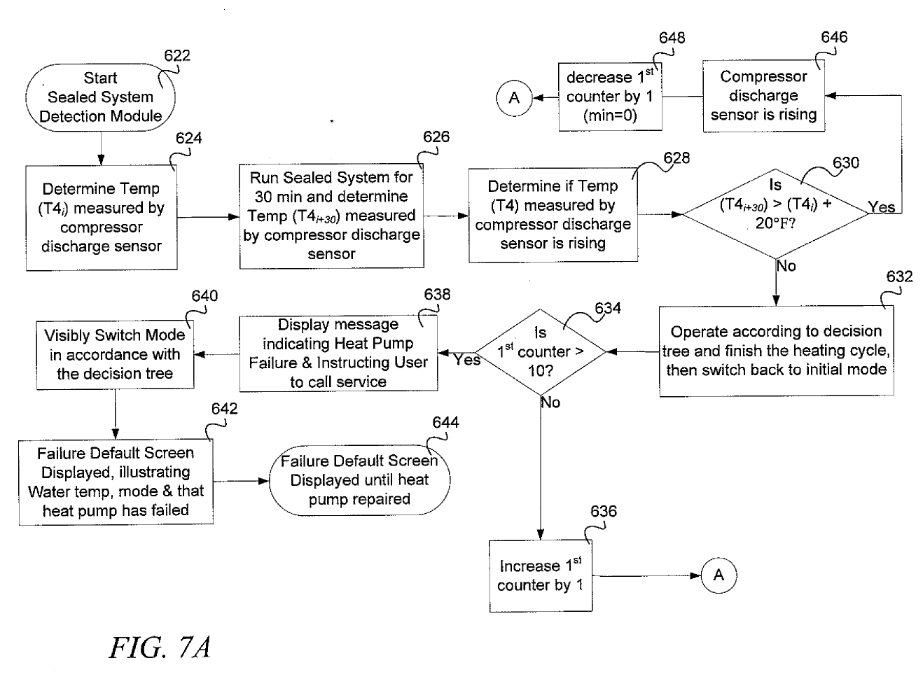

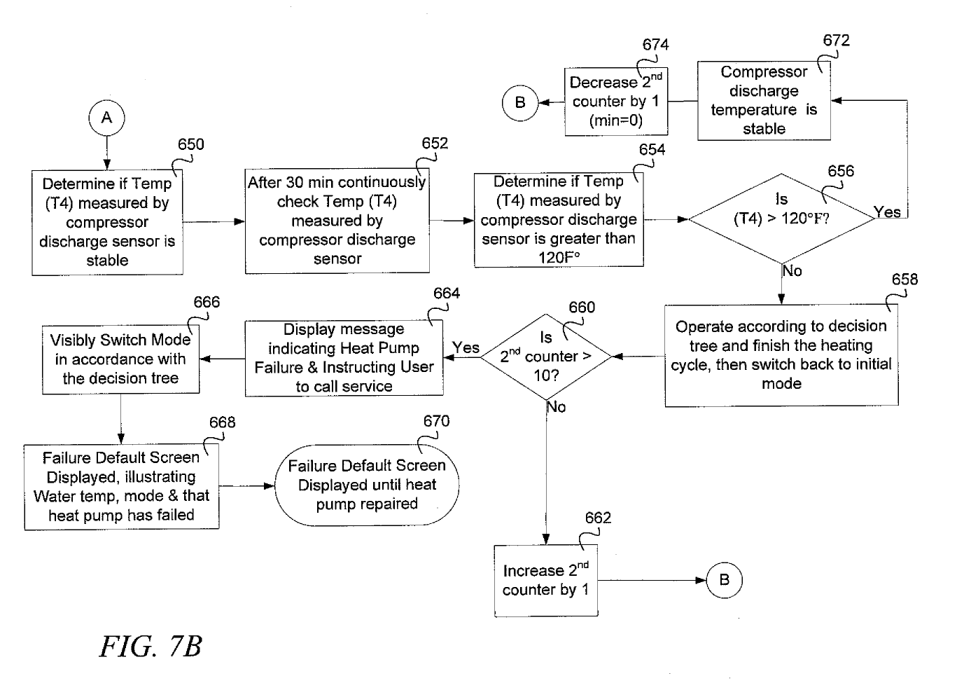

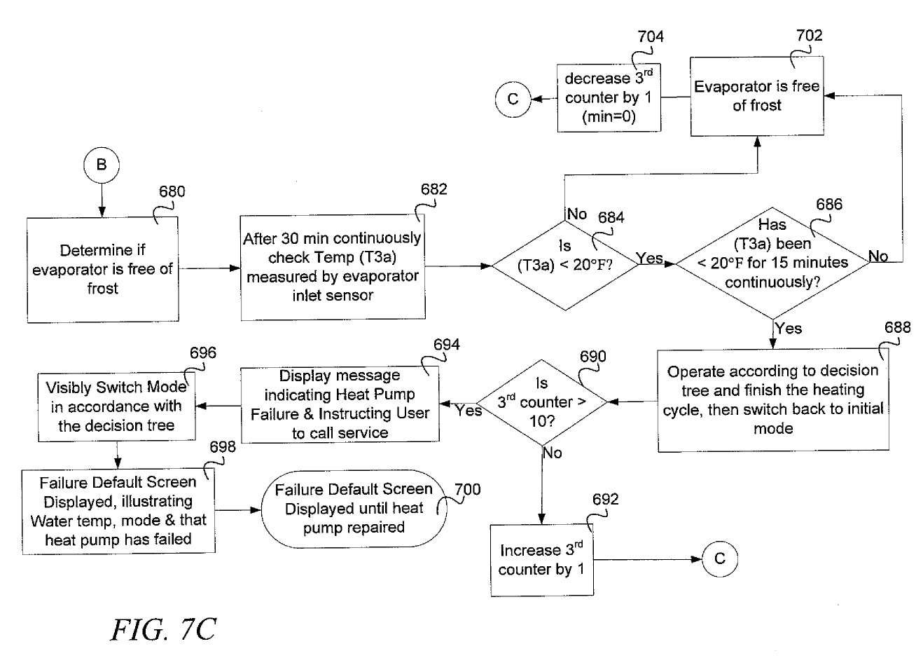

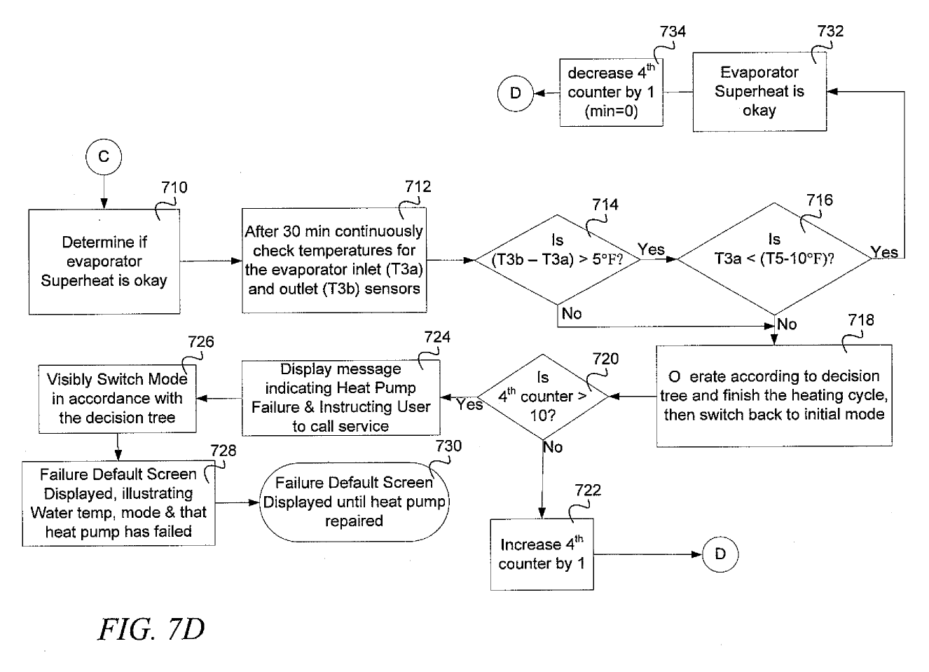

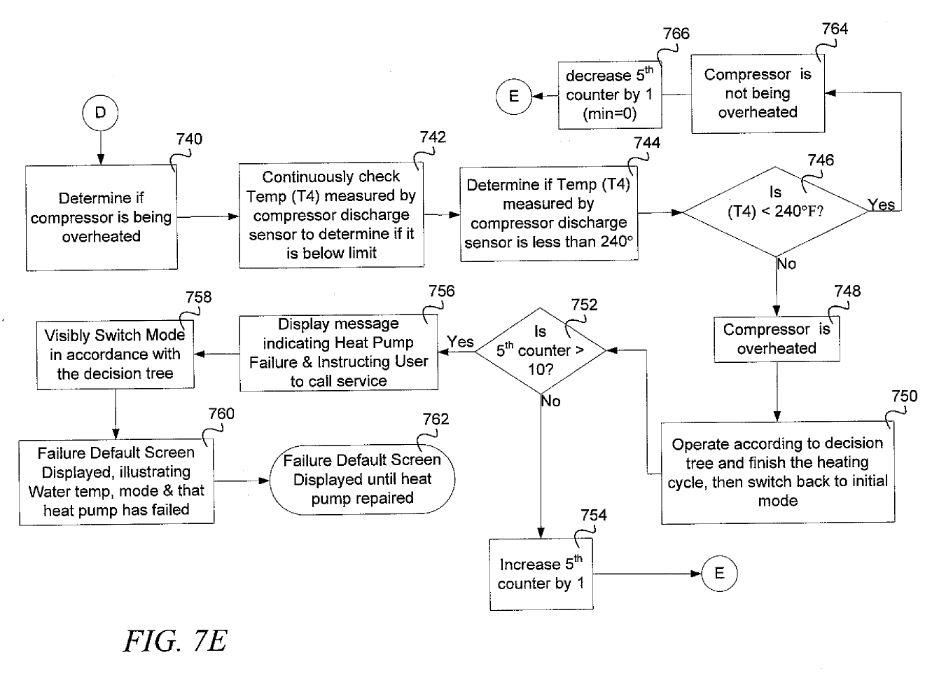

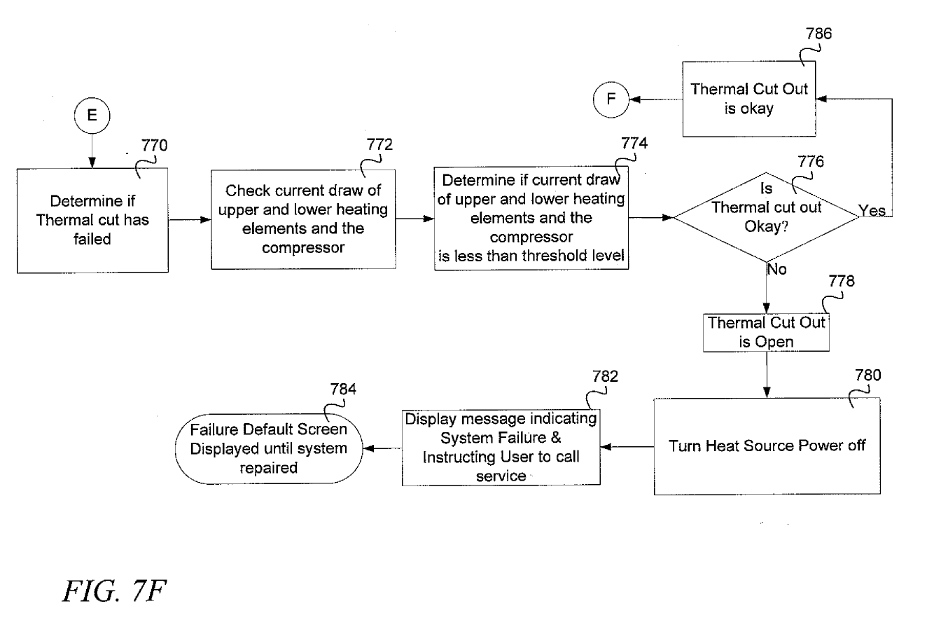

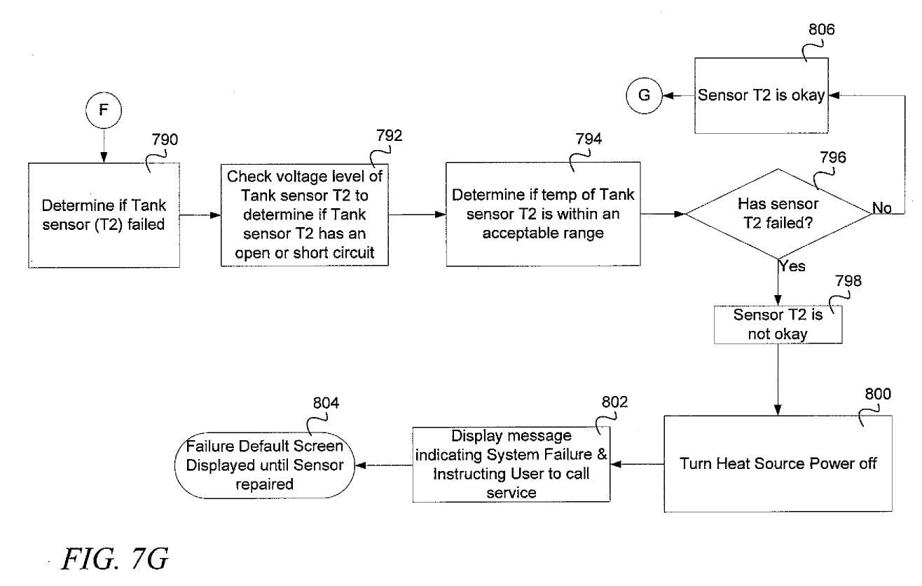

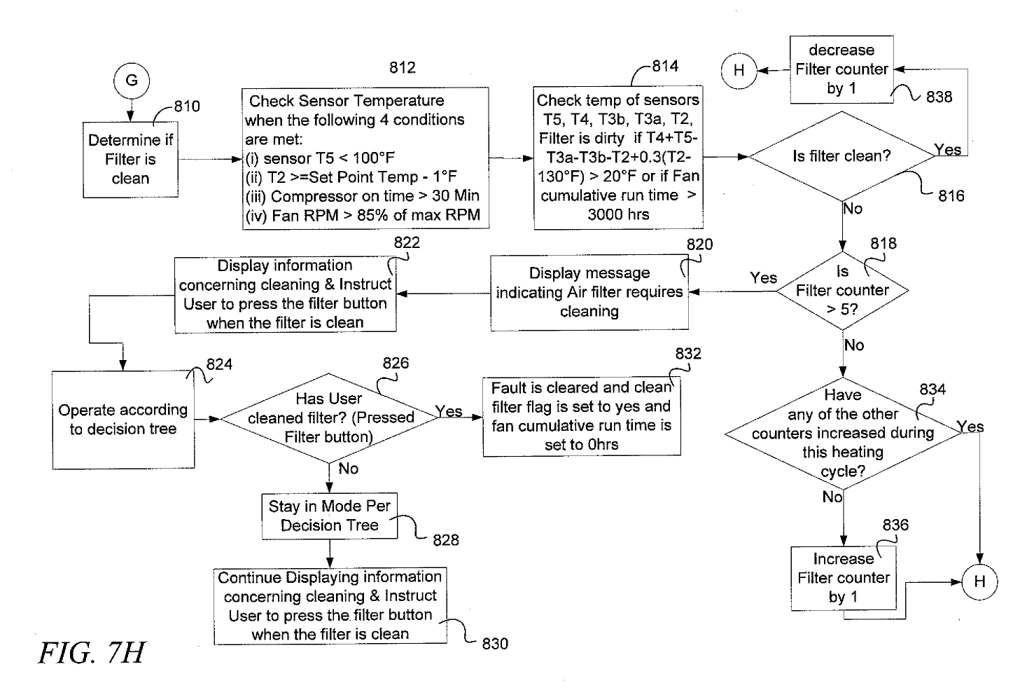

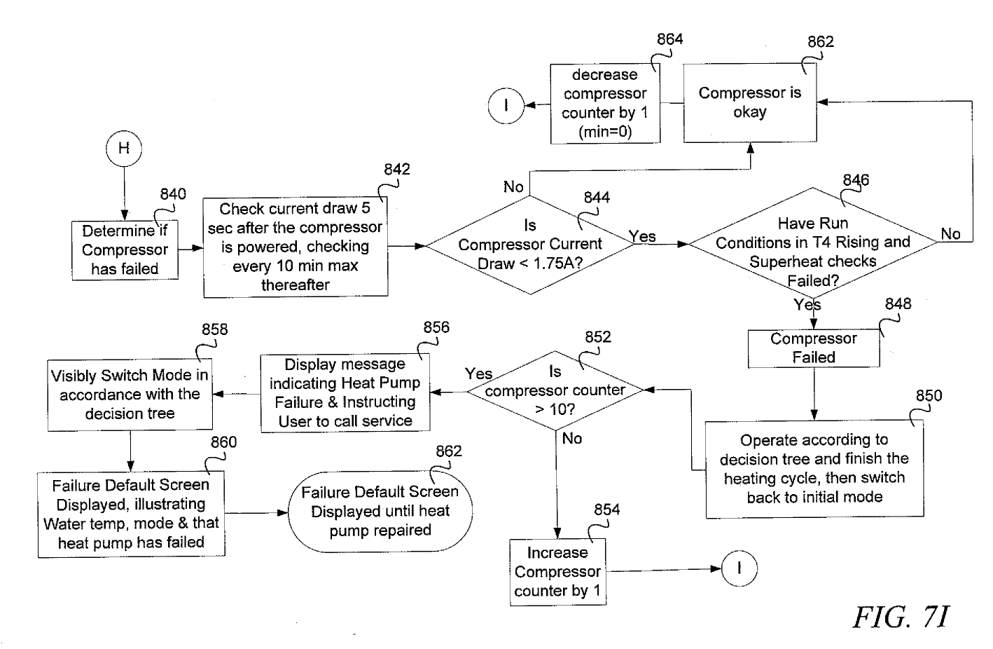

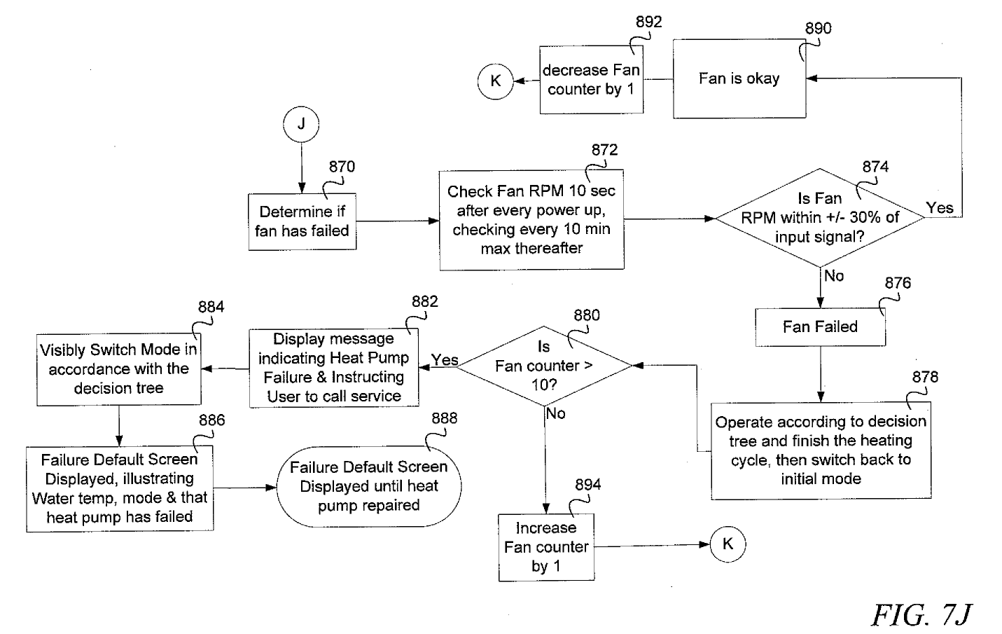

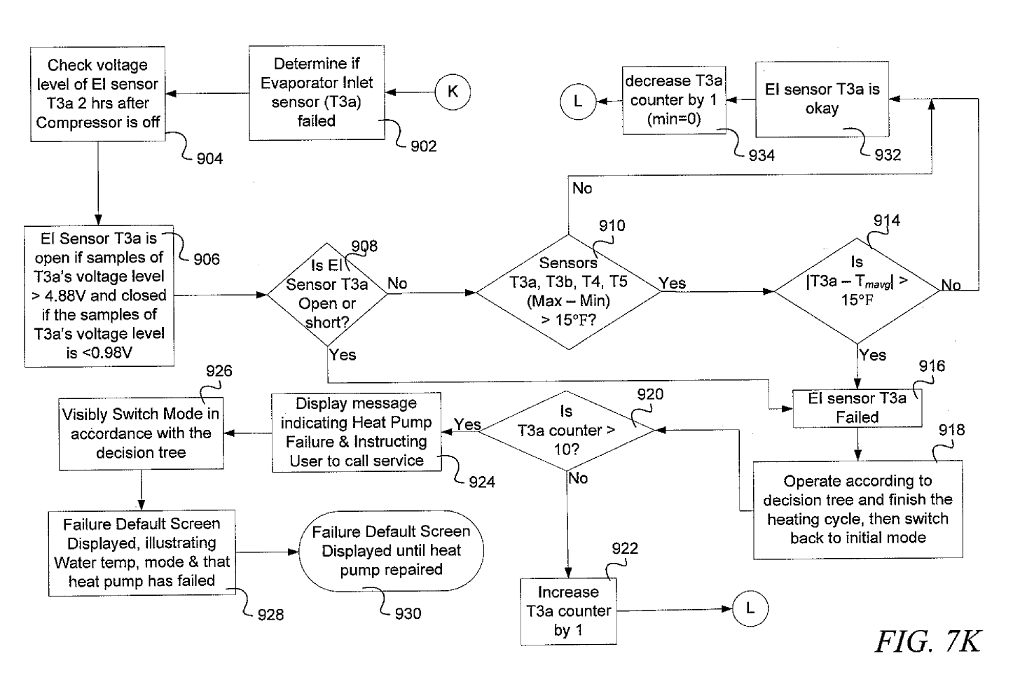

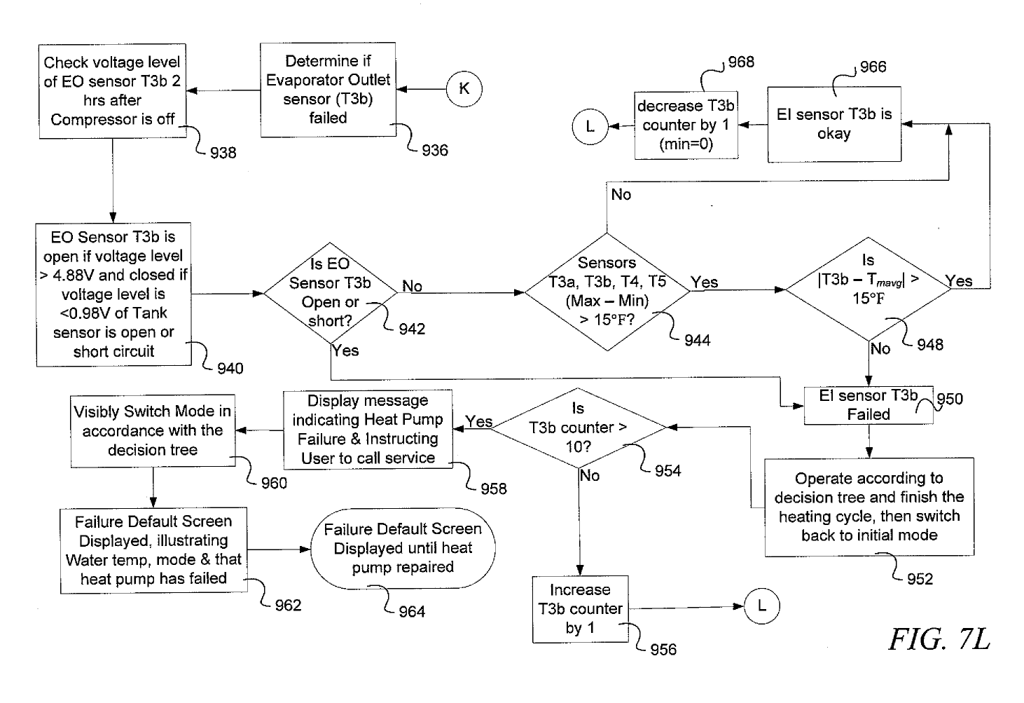

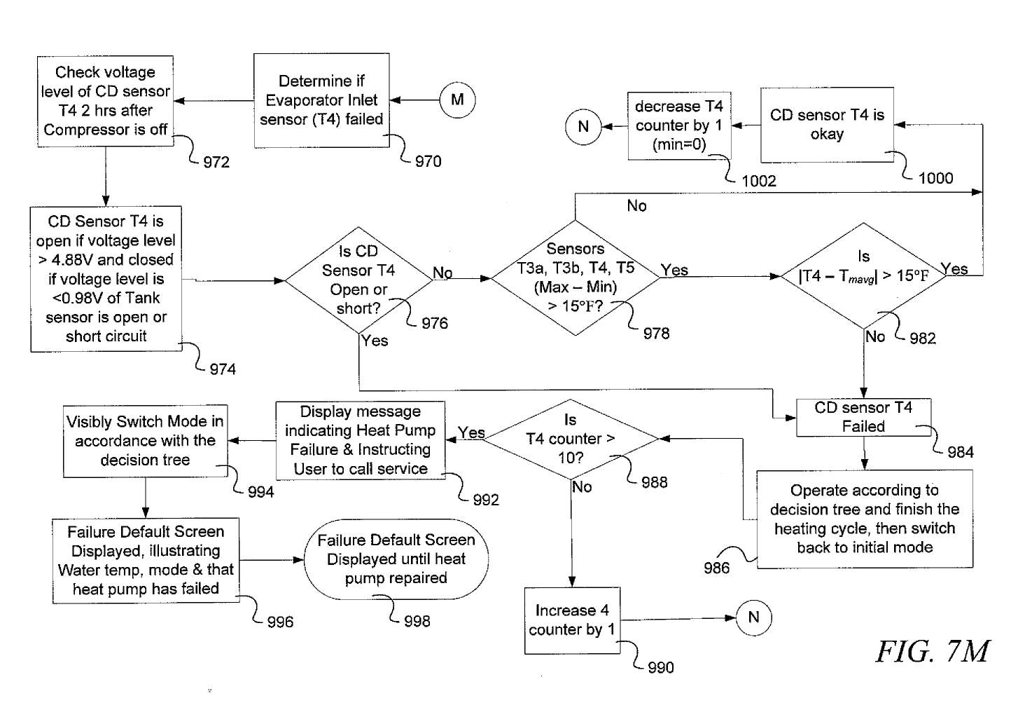

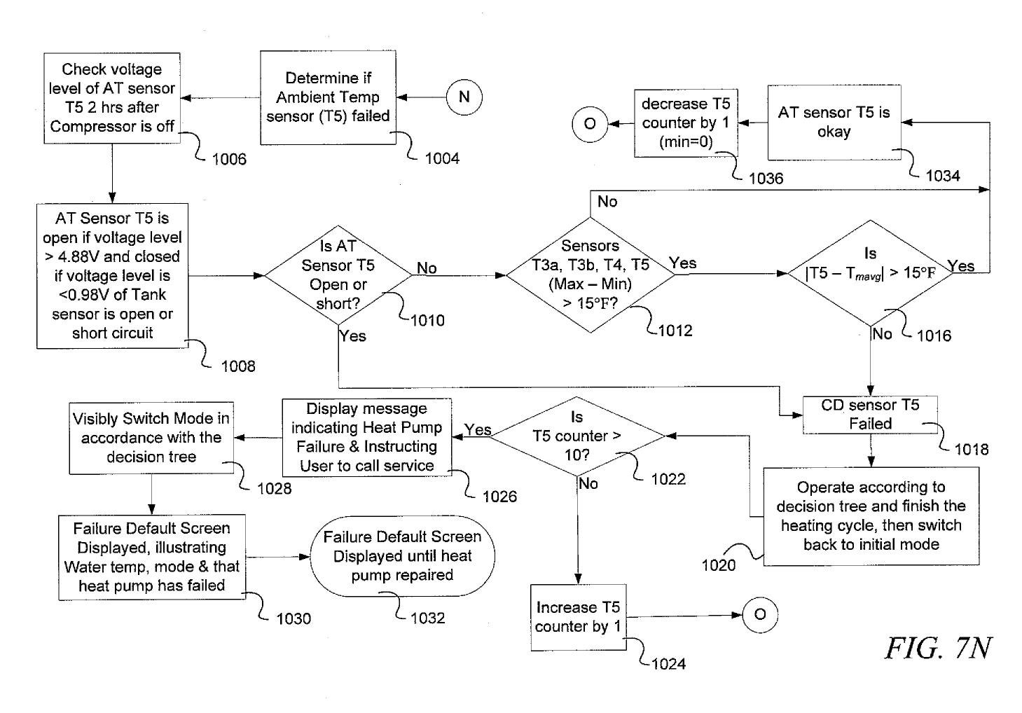

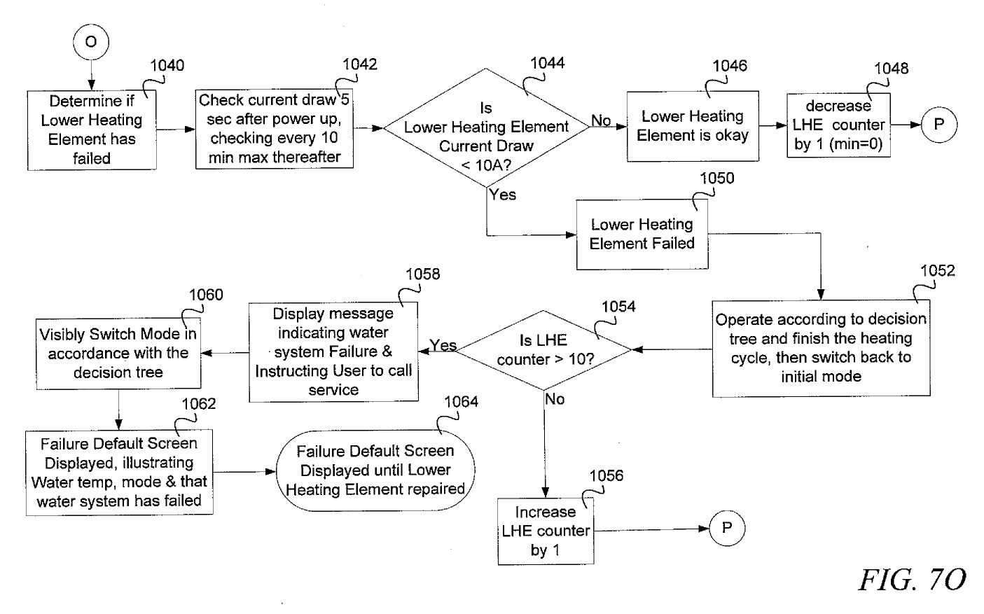

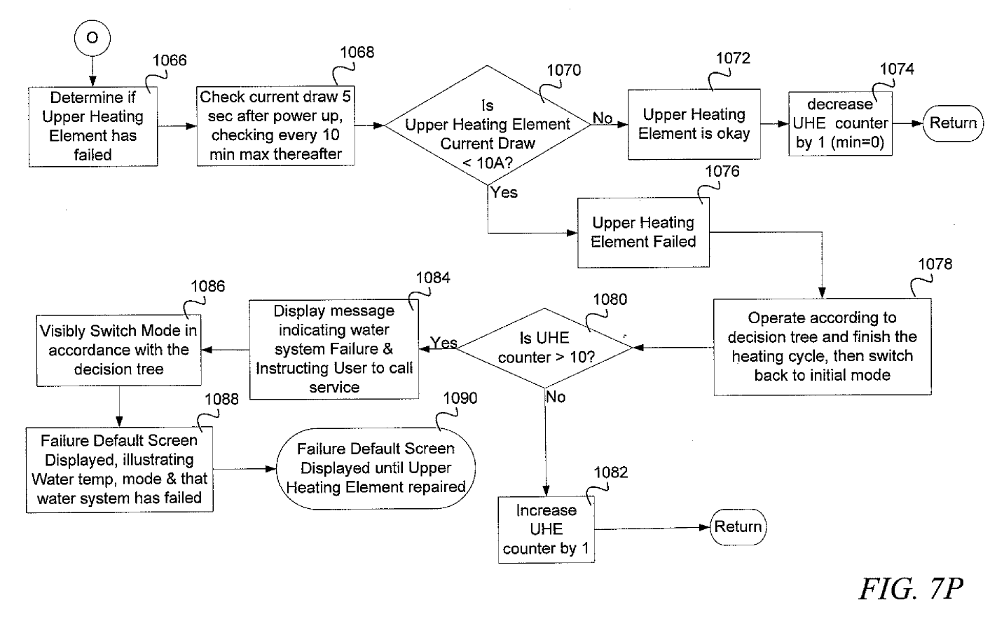

Through use of evaporator temperature sensors 128 and 130, the system may also determine if the evaporation inlet temperature is too low, indicating that there is an undercharge, fan failure, refrigerant leak, blocked valve, etc. When a determination is made that the evaporation inlet temperature is too close to the ambient temp, it may be an indication that the throttling device is clogged or that there is a refrigerant leak. If there is an initial drop in evaporation inlet temperature followed by rise in evaporation inlet temperature that would be an indication that there is a partial clog. The system may also detect when any of evaporator inlet sensor 128, evaporator outlet sensor 130, compressor discharge sensor 132, and ambient temperature sensor 136 are not functioning properly. This is done by comparing the evaporation inlet, evaporation outlet, compressor discharge temperature and ambient temperature sensor outputs from the respective sensors. When a sealed system has been off long enough to allow the sealed system to be at ambient temperature conditions (e.g., two hours) the evaporation inlet, outlet, compressor discharge and ambient output temperatures should all be very close to each other An assessment could be performed on each of the sensors. When one of the sensors is outside of an acceptable range of a band of temperatures that each sensor should be detecting, a sensor failure is indicated. FIGS. 7 and 8A-8P illustrate an embodiment of the processing logic utilized in the controller 222 to perform diagnostics that facilitate the system providing the user with information concerning proper functioning of three heating sources of the heat pump water heater, comprising the sealed system (SS), a lower heating element (LE), and an Upper heating element (UE). The system performs diagnostics in order to alert the user if one of the heating sources fails. Upon detection of a heating source failure, the diagnostics processes are configured to facilitate transmission of information to the user that includes instructions on what the user should do in the event of a heating element failure. The controller automatically modifies of mode of operation in accordance with an operational decision tree set forth in Table 1 below, so that except for the detection of system failures necessitating shut down of the entire system, the water heater may continue to be used until the user or a service provider performs necessary maintenance or service to overcome the identified failure.

TABLE 1

| | Mode | SS Fail | LE Fail | UE Fail | Mode Decision |
|---|---|---|---|---|---|
| 1 | Any | No | No | No | Run in Selected Mode |
| 2 | Any | Yes | No | No | Std Electric Mode |
| 3 | Hybrid | No | Yes | No | Hybrid Mode |
| 3 | Std Elec | No | Yes | No | Std Electric Mode |
| 3 | Heat Pump | No | Yes | No | -Heat Pump Only Mode |
| | only | | | | |
| 3 | High- | No | Yes | No | High-Demand |
| | Demand | | | | |
| 4 | Hybrid | No | No | Yes | Heat Pump Only Mode |
| 4 | Std Elec | No | No | Yes | LE Only Mode |
| 4 | Heat Pump | No | No | Yes | Heat Pump Only Mode |
| | only | | | | |
| 4 | High- | No | No | Yes | High-Demand |
| | Demand | | | | |
| 5 | Any | Yes | Yes | No | Std Electric Mode |
| 6 | Any | No | Yes | Yes | Heat Pump Only Mode |
| 7 | Any | Yes | No | Yes | LE Only Mode |
| 8 | Any | Yes | Yes | Yes | Turn Heat Source |
| | | | | | Power Off |

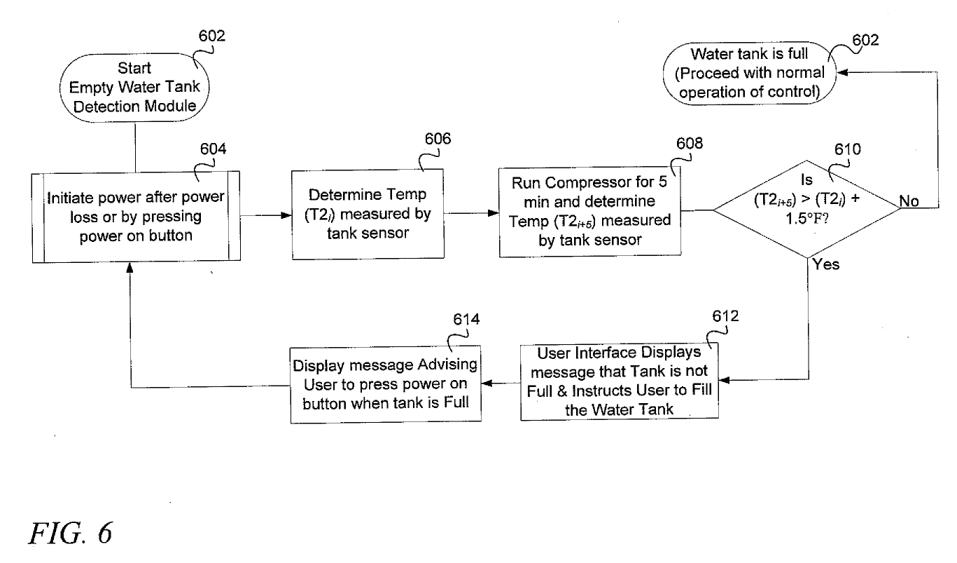

Referring to FIG. 6, FIG. 6 illustrates the process flow associated with an empty water storage tank detection implemented by the controller. The empty water storage tank detection process is implemented to insure that the electric heating elements are not energized when the tank is empty. Energizing heating elements in air will cause overheating and failure of the elements within seconds. This condition is sometimes referred to the industry as a “Dry-Fire” condition. As FIG. 6 illustrates, upon powering on the controller the empty water storage tank detection module is initiated 602. Power to the empty water storage tank detection module occurs after power loss to the entire system or by pressing the power on button 604. Initiating the empty water storage tank detection module causes the system to determine the temperature T2ᵢm easured by the sensor mounted on the water storage tank near the top of the tank 606 (126A or 126B in FIG. 1). The system then allows the compressor to run for a predetermined length of time before a second reading of the temperature of the sensor mounted on the water storage tank is measured. In the present embodiment, the compressor runs for five minutes before the temperature T2ᵢ₊₅ is measured 608. The Temperatures T2ᵢ and T2ᵢ₊₅ are processed and compared 610 to determine if the temperature T2ᵢm easured by the sensor mounted on the water storage tank has increased by at least 1.5° F. during the five minute interval. If the temperature of the sensor mounted on the water storage tank has increased by at least 1.5° F., the user interface displays a message that the water storage tank is not full and instructs the user to fill the water tank 612. In addition, the system facilitates the display of a message advising the user to press the power on button when the tank is full. Alternatively, if the temperature of the sensor mounted on the water storage tank has not increased by at least 1.5° F. after the compressor runs for a determined amount of time 610, that is an indication that the water tank is full and the system proceeds with normal control of operation 602.

Referring now to FIG. 7A-7E, FIG. 7A-7E illustrate the diagnostics logic implemented by the controller 222, to detect heat pump failures, water system failures and total system failures. The processes illustrated in these Figures perform run condition checks when the sealed system is running to detect heat pump failures and other system checks to detect water system and other system failures on a continuous basis. It is to be understood that continuous check means performing a check at least once every ten minutes. Notwithstanding, it is contemplated that continuous check can mean performing checks at intervals more frequent than once every ten minutes. A failure of any one of the run conditions is a failure of the sealed system, which failure is categorized for service as a heat pump failure.

Referring to FIG. 7A, upon initiation of the sealed system detection module 622, the first run condition check determines whether the temperature T4ᵢ measured by the compressor discharge temperature sensor is rising. The system determines the temperature T4ᵢ measured by the compressor discharge sensor 624. Next, the system runs the sealed system for at least 30 minutes and then takes another reading of the temperature T4ᵢ₊₃₀ measured by the compressor discharge sensor 626. The system determines if the temperature of the compressor discharge sensor is rising 628 by comparing the compressor discharge sensor initial temperature T4ᵢ to the temperature T4ᵢ₊₃₀ that was measured after the sealed system had been running for at least 30 minutes 630. The temperature measured by the compressor discharge sensor is considered to be rising properly when the temperature T4ᵢ₊₃₀ measured after the sealed system has been running for at least 30 minutes exceeds the initial temperature T4ᵢ by more than 20° F. If the compressor discharge sensor temperature is rising 646, a first counter is decreased by one 648 and then moves on to the next system run condition check. When the count of the first counter is already zero the count is not decreased as it is never below a count of zero.

If the temperature measured by the compressor discharge sensor does not increase by more than 20° F. after the sealed system has been running for at least 30 minutes 632, this indicates that the temperature measured by the compressor discharge sensor is not rising properly, signifying a heat pump failure. If the temperature measured by the discharge sensor is not rising, the system increases the first counter by 1, and finishes the heating cycle using the mode of operation defined by the operational decision tree of Table 1. On completion of the heating cycle the system switches back to its initial mode of operation for the next heating cycle.

Table 1 illustrates the decision tree and default mode of operation resulting from detection of a failure condition associated with one of the heat sources for the water heater. A failure of any one of the sealed system run conditions is deemed for diagnostic purposes to be a failure of the sealed system. Accordingly, as Table 1 sets forth, in any mode of operation (Hybrid, Standard Electric, Heat Pump Only or High Demand), if a sealed system failure is detected, the control system automatically switches to the standard electric mode of operation to complete the heating cycle. Next, a determination is made as to whether a first counter within the module is greater than ten 634. If the first counter is less than ten, the first counter is increased by one 636 transitions to the next run condition system check. This occurs until the count within the first counter is greater than ten.

When the count within the first counter is greater than ten, the module facilitates the transmission of information to the user interface causing the display of a message indicating that the heat pump has failed 638. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 640 so that the water heater may continue to be used until necessary maintenance is performed to overcome the identified failure of a heating source. Next, a failure default screen is displayed, illustrating the temperature of the water in the water storage tank, the mode of operation and that a heat pump has failed 642. The failure default screen is displayed continuously until the heat pump is repaired 644.

A counter is used in this and in the other diagnostic processes described herein, to enable the diagnostic system to be certain of a failure condition before displaying a condition to the user that calls for service or maintenance. By use of counters the system responds to the detection of a failure for the balance of that heat cycle, but does not immediately generate a failure display. If the condition causing the failure detection is a transient condition, on the next heat cycle the counter will be decremented by one, but if the failure causing condition is not transient it will continue to be detected during enough ensuing heat cycles that the counter will eventually reach 10 and the user will be alerted to a failure. A count of 10 has been found to provide satisfactory results in reliably detecting failures and avoiding nuisance detections. However a count of more of less than 10 could be similarly employed.

Following a run condition check to determine if the temperature measured by the discharge sensor is rising, referring to FIG. 7B, the module performs a run condition system check to determine if the discharge sensor temperature is stable. As illustrated in FIG. 7B, the system determines the temperature T4 measured by the compressor discharge sensor 650. Next, the system runs the sealed system for at least 30 minutes and then begins to continuously take readings of the temperature T4 measured by the compressor discharge sensor 652. The system determines if the temperature T4 of the compressor discharge sensor is stable by determining if the temperature T4, measured continuously after the sealed system has been running for at least 30 minutes, is greater than 120° F. 654. If the compressor discharge sensor temperature T4 is greater than 120° F. 656, the compressor discharge temperature is stable 672. This causes a second counter to be decreased by one 672 and the module to transition to the next run condition system check. When the count of the second counter is already zero, the count is not decreased as the count of the second counter shall never be below a count of zero.

When the temperature measured by the compressor discharge sensor T4 is less than 120° F., after the sealed system has been running for at least 30 minutes 656, the sensed compressor discharge temperature is deemed not stable. When the temperature measured by the discharge sensor is not stable, the system finishes the current heating cycle using the mode of operation defined by the operational decision tree and switches back to its initial mode of operation. Next, a determination is made as to whether the second counter within the module is greater than ten 660. If the second counter is less than ten, the second counter is increased by one 662 and transitions to the next run condition system check. This occurs until the count within the second counter is greater than ten.

When the count within the second counter is greater than ten, the module facilitates the transmission of information to the user interface causing the display of a message indicating that the heat pump has failed 664. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 666 so that the water heater may continue to be used until the necessary maintenance or service is provided to overcome the identified failure of a heating source. Next, a failure default screen is displayed, illustrating the temperature of the water in the water storage tank, the mode of operation and that a heat pump has failed 668. The failure default screen is displayed continuously until the heat pump is repaired 670.

Following a run condition check to determine if the temperature measured by the discharge sensor is stable, referring to FIG. 7C, the module performs a run condition check to determine if the evaporator is free of frost. As illustrated in FIG. 7C, the system determines if the evaporator is free of frost 680 by continuously checking the temperature T3a measured by the evaporator inlet sensor after the sealed system has been running for at least 30 minutes 682. The system determines if the temperature of the evaporator inlet sensor T3a is less than 20° F. 684. If the evaporator inlet sensor temperature T3a is not less than 20° F., the evaporator is free of frost 702. This causes a third counter to be decreased by one 704 and the module to transition to the next run condition system check. When the count of the third counter is already zero, the count is not decreased as the count of the second counter shall never be below a count of zero.

When the temperature measured by the evaporator inlet sensor T3a is less than 20° F., a determination is made as to whether the evaporator inlet sensor T3a has been less than 20° F. for fifteen minutes continuously 686. If the evaporator inlet sensor T3a has not been less than 20° F. for fifteen minutes continuously, the evaporator is determined to be free of frost 702. This causes a third counter to be decreased by one 704 and the module to transition to the next run condition system check. If the evaporator inlet sensor T3a has been less than 20° F. for fifteen minutes continuously, the evaporator may not be free of frost and a sealed system or heat pump failure is indicated. This causes the system to finish the current heating cycle using the mode of operation defined by the operational decision tree and switch back to its initial mode of operation for the next heat cycle. Next, a determination is made as to whether the third counter within the module is greater than ten 690. If the third counter is less than ten, the third counter is increased by one 692 and transitions to the next run condition system check. This occurs until the count within the third counter is greater than ten.

When the count within the third counter is greater than ten 690, the module facilitates the transmission of information to the user interface causing the display of a message indicating that the heat pump has failed 694. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 696 so that the water heater may continue to be used until necessary maintenance is performed to overcome the identified failure of a heating source. Next, a failure default screen is displayed, illustrating the temperature of the water in the water storage tank, the mode of operation and that a heat pump has failed 698. The failure default screen is displayed continuously until the heat pump is repaired 700.

Following a run condition check to determine if the evaporator is free of frost, referring to FIG. 7D, the module performs a run condition check to determine if the evaporator superheat is okay. As illustrated in FIG. 7D, the system determines if the evaporator superheat is okay 710 by continuously checking the temperatures measured by the evaporator inlet T3a and outlet T3b sensors after the sealed system has been running for at least 30 minutes 712. The system determines if difference between the temperatures measured by the evaporator inlet T3a and outlet T3b sensors is greater than 5° F. 714. If the difference between the temperatures measured by the evaporator inlet T3a and outlet T3b sensors is greater than 5° F., the module determines whether the evaporator inlet sensor temperature T3a is more than 10° F. less than the temperature measured by the ambient temperature sensor T5, 716. If the difference between the temperatures measured by the evaporator inlet T3a and outlet T3b sensors is greater than 5° F. and the evaporator inlet sensor temperature T3a is more than 10° F. less than the temperature measured by the ambient temperature sensor T5, the evaporator superheat is okay 732. This causes a fourth counter to be decreased by one 734 and the module to transition to the next run condition system check. When the count of the fourth counter is already zero, the count is not decreased as the count of the second counter shall never be below a count of zero.

When the difference between the temperatures measured by the evaporator inlet T3a and outlet T3b sensors is not greater than 5° F. or the evaporator inlet sensor temperature T3a is not more than 10° F. less than the temperature measured by the ambient temperature sensor T5, evaporator superheat may not be okay. A sealed system failure is signified. The system finishes the current heating cycle using the mode of operation defined by the operational decision tree and switches back to its initial mode of operation for the next heat cycle. Next, a determination is made as to whether the fourth counter within the module is greater than ten 720. If the fourth counter is not greater than ten, the fourth counter is increased by one 722 and transitions to the next run condition system check. This occurs until the count within the fourth counter is greater than ten.

When the count within the fourth counter is greater than ten 720, the module facilitates the transmission of information to the user interface causing the display of a message indicating that the heat pump has failed 724. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 726 so that the water heater may continue to be used until the necessary service or maintenance is performed to overcome the identified failure of a heating source. Next, a failure default screen is displayed, illustrating the temperature of the water in the water storage tank, the mode of operation and that a heat pump has failed 728. The failure default screen is displayed continuously until the heat pump is repaired 730.

Following a run condition check to determine if the evaporator superheat is okay, referring FIG. 7E, the module performs a run condition check to determine if the compressor is being overheated. As illustrated in FIG. 7E, the system determines if the compressor is being overheated 740 by continuously checking the temperature T4 measured by the compressor discharge sensor to see if it is below a defined limit which in the illustrative embodiments is 240° F. 746 If the temperature measured by the compressor discharge sensor is less than 240° F., the compressor is not being overheated 764. This causes a fifth counter to be decreased by one 766 and the module to transition to the water system failure diagnostics. When the count of the fifth counter is already zero, the count is not decreased as the count of the second counter shall never be below a count of zero.

When the temperature measured by the compressor discharge sensor is not less than 240° F. 746, the compressor may be overheated 748. A seated system failure is indicated. The system finishes the current heating cycle using the mode of operation defined by the operational decision tree and switches back to its initial mode of operation for the next heat cycle. Next, a determination is made as to whether the fifth counter within the module is greater than ten 752. If the fifth counter is not greater than ten, the fifth counter is increased by one 754 and transitions to water system failure diagnostics. This occurs until the count within the fifth counter is greater than ten.

When the count within the fifth counter is greater than ten 752, the module facilitates the transmission of information to the user interface causing the display of a message indicating that the heat pump has failed 756. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 758 so that the water heater may continue to be used until the necessary maintenance or service is performed to overcome the identified failure of a heating source. Next, a failure default screen is displayed, illustrating the temperature of the water in the water storage tank, the mode of operation and that a heat pump has failed 760. The failure default screen is displayed continuously until the heat pump is repaired 762.

Following a run condition check to determine if the compressor is being overheated, the module performs water system diagnostics to determine if a thermal cut out (TCO) device has failed. In situations where the controller happens to fail or there is a runaway heating element that continues to heat water within the water storage tank and fails to disengage, the TCO acts as a safety device. Mounted on the water storage tank, the TCO functions to prevent water from getting too hot. When a TCO device gets too hot, because it has a bimetal within it, it opens or switches so that all power is cut to all heating sources within the system. The system check that is performed to assess whether the TCO has failed is illustrated in FIG. 7F.

As FIG. 7F illustrates, a determination is made as to whether a thermal cut out has failed (opened) 770 by checking the current draw of the upper and lower heating elements and the compressor 772. The level of current to the heating elements and the compressor is measured by a toroidal current transformer included as part of the controller and positioned to respond to the current flowing in L2 in a conventional manner. Since only one of these heat sources can be operating at a time, the current in L2 represents the current drawn by the then operating one of the three heat sources. A determination is made as to whether the current draw of the then operating one of the upper and lower heating elements and the compressor is less than a threshold level for those devices 774. If the current draw of operating one of the upper heating element, lower heating element and compressor is greater than a threshold level, which in the illustrative embodiments is 10 amps for the upper and lower heating elements and 1.75 amps for the compressor, the thermal cut out has not failed 776 and is okay 786. This results in the module transitioning to the next system diagnostic check. If the current draw of the upper and lower heating elements and the compressor is less than a threshold level, the thermal cut out has failed 776, indicating that the thermal cut is open 778. When the TCO fails, there would not be current flowing into either of the upper and lower heating elements or the compressor. Upon recognition that the TCO is open (failed), the power to the heat source is turned off 780. Next, the module facilitates the transmission of information to the user interface causing the display of a message indicating that there has been a system failure 782 and that there will be no hot water. The message displayed also includes instructions on what the user should do in the event of a system failure along with instructions to the user to call a service technician when applicable. Next, a failure default screen is displayed continuously until the system is repaired 784.

Following the module's performance of diagnostics to determine if a TCO has failed, referring to FIG. 7G, a determination is made as to whether the sensor T2 mounted on the water storage tank near the top of the tank has failed 790. As FIG. 7G illustrates, a check of the voltage level of the sensor T2 mounted on the water storage tank near the top of the tank 792 is performed. During the check, a determination is made as to whether the measured voltage level of the sensor T2 indicates that sensor T2 is an open or short circuit. In the present embodiment, the logic circuit on the control board is a five volt system. Accordingly, if the voltage level measured of sensor T2 is greater than 4.88 volts, sensor T2 has an open circuit. On the other hand, the voltage level measured of sensor T2 is less than 0.98 volts, sensor T2 has a short circuit. The module checks the range of the voltage level measured of sensor T2 792. The module also checks whether the temperature measured by sensor T2 is out of range 794. In the present embodiment, the range within which the temperature measured for sensor T2 should fall is between 30° F. and 170° F.

When the voltage measured indicates that sensor T2 is not open or shorted, and the temperature measured by sensor T2 is within a range, which is an indication that sensor T2 has not failed 796 and is okay 806. This results in the module transitioning to the next water system diagnostic check. On the other hand, when the voltage measured indicates that sensor T2 is open or shorted, or that the temperature measured by sensor T2 is within a range, which indicates that sensor T2 has failed 796 and is not okay 798. Upon recognition that sensor T2 is not okay, this constitutes a system failure that requires the power to the heat sources to be turned off 800. Next, the module facilitates the transmission of information to the user interface causing the display of a message indicating that there has been a system failure 802. The message displayed also includes instructions on what the user should do in the event of a system failure along with instructions to the user to call a service technician when applicable. Next, a failure default screen is displayed continuously until the system is repaired 804.

Following the module's performance of diagnostics to determine if sensor T2 has failed, referring to FIG. 7H, a determination is made as to whether the air filter positioned in front of the evaporator is clean. The purpose of the air filter is to prevent dust from building up on the evaporator over time and clogging the evaporator. As FIG. 7H illustrates, a determination of whether the filter is clean 810 is performed by checking the output temperatures of the temperature sensors 812. In the present embodiment, the sensor outputs that are checked are the outputs for the ambient temperature sensor measuring T5, (sensor 136) compressor discharge temperature sensor measuring T4 (sensor 132), evaporator outlet temperature sensor measuring T3b (sensor 128), evaporator inlet temperature sensor measuring T3a (sensor 130) and water storage tank temperature sensor measuring T2 (sensor 126) 812. As the air filter becomes clogged over time, the air flow over the evaporator is reduced. When the air flow declines the discharge temperature of the compressor T4 and the ambient temperature T5 tend to increase. The inlet and outlet evaporator temperatures T3a and T3b, and the water temperature T2, tend to decrease. It has been empirically determined that the following formula which adds the temperatures that tend to increase and subtracts the temperatures that tend to decrease, when adjusted by a compensation factor which is a function of water temperature T2 provides a reliable indicator of when the filter is reducing air flow to the point of needing cleaning or replacement. More specifically, the filter is determined to be dirty if [T4+T5−T3a−T3b−T2+0.3(T2−130)>20° F.]. However certain operating conditions must be satisfied for this formula to provide satisfactory results. First, the ambient temperature must be low enough for the fans to be generating significant airflow. When the ambient temperature is relatively high, less airflow is needed for efficient evaporator performance. In the illustrative embodiments, when the ambient temperature is not less than 100 degrees F, the variable speed fans are not running fast enough for the effect of the filter on airflow to be detected. Similar reasoning is applicable to the requirement that fan speed must be greater than 85% of maximum. The requirement that T2 be no more than 1 degree less than the set point is so that the water temperature is substantially the same throughout the tank. Finally the requirement for thirty minutes of compressor run time is to establish steady state operating conditions for the compressor discharge temperature. When these conditions are satisfied the sensor temperatures are processed according to the formula and if the result is not greater than 20 degrees F., the filter is considered clean. When the filter is clean 816, a filter counter is decreased by a count of one and the module to transitions to the next diagnostic system check 838. When the count of the filter counter is already zero, the count is not decreased as the count of the second counter shall never be below a count of zero.

If the formula generates a temperature value that is greater than 20 degrees F., the filter is determined to be not clean 816 and the modules determines whether the filter counter is greater than a count of five 818. When the filter counter is greater than a count of five, the module facilitates the transmission of information to the user interface causing the display of a message indicating that the air filter requires cleaning 820. The message displayed also includes instructions on what the user should do to clean the filter along with instructions to the user to press the filter button when the filter is clean 822. The module also interacts with the controller to complete the heat cycle in accordance with an operational decision tree set forth in Table 1 824. The system stays in the mode of operation defined by the decision tree 828 and displays information concerning the cleaning of the filter and instructs the user to press the filter button once the filter is clean 830. When the user has cleaned the filter, and presses the filter button 826, the fault is cleared and a clean filter flag is set to yes and the fan cumulative run time is set to zero hours 832.

When the filter counter is not greater than a count of five 818, a determination is made as to whether any of the other error counters have been increased during the same heating cycle that the dirty filter is detected 834. If other error counters have not been increased during the same heating cycle that the dirty filter is detected, the filter counter is increased by one 836. Next, the module transitions to the next system diagnostic check. If any other error counters have been increased during the same heating cycle that the dirty filter is detected, the filter counter is not increased and the module transitions to the next system diagnostic check. An error counter other than the filter counter may have increased during the same heating cycle that the dirty filter is detected when the compressor, fans, sensors or one of the above run conditions fails during the same heating cycle. Under these circumstances, the module gives priority to the other error counts because a failure detected by one or more of the other run condition checks may have impacted the results so as to indicate a dirty filter condition due to a sensor failure not a clogged filter.

Following the module's performance of diagnostics to determine whether the air filter positioned in front of the evaporator is clean, referring to FIG. 7I, the module determines whether the compressor has failed 840. In determining whether the compressor has failed, a check of the current drawn by the compressor is checked five seconds after the compressor is powered and every ten minutes maximum thereafter 842. If the current drawn by the compressor is not low (less than 1.75 Amps 844), the compressor is okay 862 and a compressor counter is decreased by one 864 and the module transitions to the next system check. When the count of the compressor counter is already zero, the count is not decreased as it is never below a count of zero. If the current drawn by the compressor is low (less than 1.75 Amps) 844, the compressor may not be okay and the system determines whether both the run condition check to determine if T4 is rising properly and to determine if superheat is okay, detected failures 846. If not, the compressor is okay 862 and a compressor counter is decreased by one 864 and the module transitions to the next system check. If the T4 rising and the superheat checks did not both fail, the compressor must be operating and the low current condition signified by the current sensor may indicate a current sensor failure. However, when the current is low and the T4 and superheat checks both failed, a compressor failure is signified 848. The system finishes the current heating cycle using the mode of operation defined by the operational decision tree switches back to its initial mode of operation for the next heat cycle. Next, a determination is made as to whether the compressor counter within the module is greater than ten 852. If the compressor counter is not greater than ten, the compressor counter is increased by one 854 and transitions to the next run condition system check. This occurs until the count within the compressor counter is greater than ten.

When the count within the compressor counter is greater than ten 852, the module facilitates the transmission of information to the user interface causing the display of a message indicating that the heat pump has failed 856. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 858 so that the water heater may continue to be used until necessary maintenance or service is performed to overcome the identified failure of a heating source. Next, a failure default screen is displayed, illustrating the temperature of the water in the water storage tank, the mode of operation and that a heat pump has failed 860. The failure default screen is displayed continuously until the heat pump is repaired 862.

Following the module's performance of diagnostics to determine whether the compressor has failed, referring to FIG. 7J, the module determines whether the fan has failed 870. The module determines whether the fan has failed by checking the fan RPM ten seconds after every power up of the sealed system. The fan is configured with an RPM feedback. The module reads data representative of the fan RPM every ten minutes maximum thereafter 872 and processes the data read to determine if the fan RPM is within plus or minus 30% of the expected RPM associated with the given input signal 874. For example, if the input signal is 60% input, the actual RPM output should be within plus or minus 30% of the RPM associated with the 60% input. If the fan RPM is within plus or minus 30%, the fan is okay 890 and a fan counter is decreased by one 892 and the module transitions to the next system check.

However, if the fan RPM is not within plus or minus 30% of the expected RPM associated with the given input signal, a fan failure is signified 876. The system finishes the current heating cycle using the mode of operation defined by the operational decision tree and switches back to its initial mode of operation. Next, a determination is made as to whether the fan counter is greater than ten 880. If the fan counter is not greater than ten, the fan counter is increased by one 894 and transitions to the next run condition system check. This occurs until the count within the fan counter is greater than ten.

When the count within the fan counter is greater than ten 880, the module facilitates the transmission of information to the user interface causing the display of a message indicating that the heat pump has failed 882. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 884 so that the water heater may continue to be used until necessary maintenance or service is performed to overcome the identified failure. Next, a failure default screen is displayed, illustrating the temperature of the water in the water storage tank, the mode of operation and that a heat pump has failed 886. The failure default screen is displayed continuously until the heat pump is repaired 888.

Following the module's performance of diagnostics to determine whether the fan has failed, referring to FIG. 7K, the module determines whether the evaporator inlet sensor T3a has failed 902. The module determines whether the evaporator inlet sensor T3a has failed by first checking the voltage level of the evaporator inlet sensor T3a. The voltage level is checked two hours after the compressor has been turned off 904. The evaporator inlet sensor T3a has an open circuit if the voltage level measured is greater than 4.88 volts and a closed circuit if the voltage level measured is less than 0.98 volts 906. If the evaporator inlet sensor T3a has an open or short circuit 908, a failure of the evaporator inlet sensor T3a is signified 916. However, if the evaporator inlet sensor does not have an open or closed circuit 908, the module measures the output temperatures of the ambient sensor T5, the compressor discharge sensor T4, the evaporator outlet sensor T3b and the evaporator inlet sensor T3a. Next the module determines the maximum and minimum of these four sensors and calculates the difference between the maximum and minimum temperatures. If the difference is greater than 15 degrees F., one of the sensors is likely to have failed. To determine which sensor failed, the system calculates the average value, Tm_{avg}, of the two intermediate temperature values, that is the values that were not the maximum or minimum values. The system then calculates the absolute value of the difference between the sensor value and Tm_{avg} for each of the four sensors, T3a, T3b, T4 and T5. An absolute value difference of greater than 15 degrees F. for any particular sensor signifies a sensor out of range failure of that sensor. So to check T3a, the system determines if the absolute value of the difference between T3a and Tm_{avg} is greater than 15 degrees F. 910. If not, the evaporator inlet sensor T3a is okay 932 and an evaporator inlet sensor counter is decreased by one 934 and the module transitions to the next system check.

However, if this difference is greater than 15 degrees F., a failure of the evaporator inlet sensor T3a is signified 916. The system finishes the current heating cycle using the mode of operation defined by the operational decision tree, and switches back to its initial mode of operation for the next heating cycle 918. Next, a determination is made as to whether the evaporator inlet sensor counter within the module is greater than ten 920. If the evaporator inlet sensor counter is not greater than ten, the evaporator inlet sensor counter is increased by one 922 and transitions to the next run condition system check. This occurs until the count within the evaporator inlet sensor counter is greater than ten.

When the count within the evaporator inlet sensor counter is greater than ten 920, the module facilitates the transmission of information to the user interface causing the display of a message indicating that the heat pump has failed 924. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 926 so that the water heater may continue to be used until the necessary maintenance or service is performed to overcome the identified failure. Next, a failure default screen is displayed, illustrating the temperature of the water in the water storage tank, the mode of operation and that a heat pump has failed 928. The failure default screen is displayed continuously until the heat pump is repaired 930.

Following the module's performance of diagnostics to determine whether the evaporator inlet sensor T3a has failed, referring to FIG. 7L, the module determines whether the evaporator outlet sensor T3b has failed 936. The module determines whether the evaporator outlet sensor T3b has failed by checking the voltage level of the evaporator outlet sensor T3b. The voltage level is checked two hours after the compressor has been turned off 938. The evaporator outlet sensor T3b has an open circuit if the voltage level measured is greater than 4.88 volts and a closed circuit if the voltage level measured is less than 0.98 volts 940. If the evaporator outlet sensor T3b has an open or short circuit 942, a failure of the evaporator outlet sensor T3b is signified 950. However, if the evaporator outlet sensor T3b does not have an open or short circuit 942, the module measures the output temperatures of the ambient sensor T5, the compressor discharge sensor T4, the evaporator outlet sensor T3b and the evaporator inlet sensor T3a. Next the module calculates the difference between the maximum and the minimum of these four sensors and determines if the difference between the maximum and minimum temperatures is greater than 15 degrees F. 944. If it is, one of the sensors is likely to have failed. To determine if it is T3b, the system determines if the absolute value of the difference between T3b and Tm_{avg} is greater than 15 degrees F. 910. If not, the evaporator outlet sensor T3b is okay 966 and an evaporator outlet sensor counter is decreased by one 968 and the module transitions to the next system check.

However, if absolute value of the difference is greater than 15 degrees F., a failure of the evaporator outlet sensor T3b is indicated 950. The system finishes the current heating cycle using the mode of operation defined by the operational decision tree and switches back to its initial mode of operation for the next heating cycle. Next, a determination is made as to whether the evaporator outlet sensor counter within the module is greater than ten 954. If the evaporator outlet sensor counter is not greater than ten, the evaporator outlet sensor counter is increased by one 956 and transitions to the next run condition system check. This occurs until the count within the evaporator outlet sensor counter is greater than ten.

When the count within the evaporator outlet sensor counter is greater than ten 954, the module facilitates the transmission of information to the user interface causing the display of a message indicating that the heat pump has failed 958. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 960 so that the water heater may continue to be used until the necessary maintenance or service is performed to overcome the identified failure. Next, a failure default screen is displayed, illustrating the temperature of the water in the water storage tank, the mode of operation and that a heat pump has failed 962. The failure default screen is displayed continuously until the heat pump is repaired 964.

Following the module's performance of diagnostics to determine whether the evaporator outlet sensor T3b has failed, referring to FIG. 7M, the module determines whether the compressor discharge sensor T4 has failed 970. The module determines whether the compressor discharge sensor T4 has failed by checking the voltage level of the compressor discharge sensor T4. The voltage level is checked two hours after the compressor has been turned off 972. The compressor discharge sensor T4v has an open circuit if the voltage level measured is greater than 4.88 volts and a closed circuit if the voltage level measured is less than 0.98 volts 974. If the compressor discharge sensor T4 has an open or short circuit 976, a failure of the compressor discharge sensor T4 is signified 984. However, if the compressor discharge sensor T4 does not have an open or short circuit 976, the module measures the output temperatures of the ambient sensor T5, the compressor discharge sensor T4, the evaporator outlet sensor T3b and the evaporator inlet sensor T3a. Next the module determines whether the maximum of the output temperatures measured less the minimum of the output temperatures measured is greater than 15° F. 978. If the maximum of the output temperatures measured less the minimum of the output temperatures measured is not greater than 10° F., the compressor discharge sensor is okay 1000 and a compressor discharge sensor T4 counter is decreased by one 1002 and the module transitions to the next system check.

However, if the maximum of the output temperatures measured less the minimum of the output temperatures measured is greater than 15° F., a failure of one of the four sensors is likely, and a determination is made T4 is the failed sensor by determining if the absolute value of the difference between T4 and Tm_{avg} is greater than 15 degrees F. 982. If it is not greater, the compressor discharge temperature sensor T4 is okay 1000 and the T4 sensor counter is decreased by one 1002 and the module transitions to the next system check. However, if it is greater 982, a failure of the compressor discharge sensor T4 is signified 984. The system finishes the current heating cycle using the mode of operation defined by the operational decision tree and switches back to its initial mode of operation for the next heating cycle. Next, a determination is made as to whether the T4 sensor counter within the module is greater than ten 988. If it is not greater than ten, the counter is increased by one 990 and transitions to the next run condition system check. This occurs until the count is greater than ten.

When the count is greater than ten 988, the module facilitates the transmission of information to the user interface causing the display of a message indicating that the heat pump has failed 992. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 994 so that the water heater may continue to be used until the necessary maintenance or service is provided to overcome the identified failure. Next, a failure default screen is displayed, illustrating the temperature of the water in the water storage tank, the mode of operation and that a heat pump has failed 996. The failure default screen is displayed continuously until the heat pump is repaired 998.

Following the module's performance of diagnostics to determine whether the compressor discharge sensor T4 has failed, referring to FIG. 7N, the module determines whether the ambient temperature sensor T5 has failed 1004. The module determines whether the ambient temperature sensor T5 has failed by checking the voltage level of the ambient temperature sensor T5. The voltage level is checked two hours after the compressor has been turned off 1006. The ambient temperature sensor T5 has an open circuit if the voltage level measured is greater than 4.88 volts and a closed circuit if the voltage level measured is less than 0.98 volts 1008. If the ambient temperature sensor T5 has an open or short circuit 1010, the ambient temperature sensor T5 fails 1018. However, if the ambient temperature sensor T5 does not have an open or short circuit 1010, the module measures the output temperatures of the ambient sensor T5, the compressor discharge sensor T4, the evaporator outlet sensor T3b and the evaporator inlet sensor T3a. Next the module determines whether the maximum of the output temperatures measured less the minimum of the output temperatures measured is greater than 15° F. 1012. If the maximum of the output temperatures measured less the minimum of the output temperatures measured is not greater than 15° F., the ambient temperature sensor T5 is okay 1034 and a ambient temperature sensor counter is decreased by one 1036 and the module transitions to the next system check.

However, if the maximum of the output temperatures measured less the minimum of the output temperatures measured is greater than 15° F., a determination is made as to whether the absolute value of the difference between T5 and Tm_{avg} is greater than 15 degrees F. 1016. If it is not greater, the ambient temperature sensor T5 is okay 1034 and an T5 counter is decreased by one 1036 and the module transitions to the next system check. However, if it is greater 1016, a failure of the ambient temperature sensor T5 is signified 1018. The system finishes the current heating cycle using the mode of operation defined by the operational decision tree and switches back to its initial mode of operation for the next heating cycle. Next, a determination is made as to whether the T5 counter is greater than ten 1022. If it is not greater than ten, the counter is increased by one 1024 and the system transitions to the system check. This occurs until the count is greater than ten.

When the count is greater than ten 1022, the module facilitates the transmission of information to the user interface causing the display of a message indicating that the heat pump has failed 1026. The message displayed also includes instructions on what the user should do in the event of a heat pump failure along with instructions to the user to call a service technician when applicable. The module also interacts with the controller to facilitate automatic modification of mode of operation, in accordance with an operational decision tree set forth in Table 1; and display of the mode change 1028 so that the water heater may continue to be used until the necessary maintenance or service is provided to overcome the identified failure. Next, a failure default screen is displayed, illustrating the temperature of the water in the water storage tank, the mode of operation and that a heat pump has failed 1030. The failure default screen is displayed continuously until the heat pump is repaired 1032.

Following module's performance of diagnostics to determine whether the ambient temperature sensor T5 has failed, referring to FIG. 7O, the module performs diagnostics to determine if the lower heating element has failed 1040. In determining whether the lower heating element has failed, the system checks the current draw of the heating element five seconds after power up of the system, checking the current level every ten minutes maximum thereafter 1042. Next a determination is made as to whether the lower heating element current draw is less than ten Amps 1044. If the current drawn is not less than ten Amps, the lower heating element is okay 1046. This causes a lower heating element counter to be decreased by one 1048 and the module to transition to the next system check. When the count of the lower heating element counter is already zero, the count is not decreased as the count of the second counter shall never be below a count of zero.

When the current draw of the lower heating element is less than ten Amps 1044, a failure of the lower heating element is signified 1050. The system finishes the current heating cycle using the mode of operation defined by the operational decision tree and switches back to its initial mode of operation for the next heating cycle. Next, a determination is made as to whether the lower heating element counter is greater than ten 1054. If the lower heating element counter is less than ten, the lower heating element counter is increased by one 1056 and transitions to the next system check. This occurs until the count within the lower heating element counter is greater than ten.

When the count within the lower heating element counter is greater than ten, the module facilitates the transmission of information to the user interface causing the display of a message indicating that the water system has failed 1058. The message displayed also includes instructions on what the user should do in the event of a water system failure along with instructions to the user to call a service technician when applicable. The module also interacts with the controller to facilitate automatic modification of mode of operation, in accordance with an operational decision tree set forth in Table 1; and display of the mode change 1060 so that the water heater may continue to be used until the necessary maintenance or service is provided to overcome the identified failure of a heating source. Next, a failure default screen is displayed, illustrating the temperature of the water in the water storage tank, the mode of operation and that a water system has failed 1062. The failure default screen is displayed continuously until the system is repaired 1064.

Following module's performance of diagnostics to determine whether the lower heating element has failed, referring to FIG. 7P, the module performs diagnostics to determine if the upper heating element has failed 1066. In determining whether the upper heating element has failed, the system checks the current draw of the heating element five seconds after power up of the system, checking the current level every ten minutes maximum thereafter 1068. Next a determination is made as to whether the current drawn by the upper heating element is less than ten Amps. If the current drawn is not less than ten Amps, the upper heating element is okay 1072. This causes an upper heating element counter to be decreased by one 1074 and the module returns to start 622 (FIG. 7A). When the count of the upper heating element counter is already zero, the count is not decreased as the count of the upper heating element counter shall never be below a count of zero.

When the current drawn by the upper heating element is less than ten Amps 1070, a failure of the upper heating element is signified 1076. The system finishes the current heating cycle using the mode of operation defined by the operational decision tree and switches back to its initial mode of operation for the next heat cycle. Next, a determination is made as to whether the upper heating element counter is greater than ten 1080. If the upper heating element counter is less than ten, the upper heating element counter is increased by one 1082 and the module returns to start 622 (FIG. 7A).

When the count within the upper heating element counter is greater than ten, the module facilitates the transmission of information to the user interface causing the display of a message indicating that the water system has failed 1084. The message displayed also includes instructions on what the user should do in the event of a water system failure along with instructions to the user to call a service technician when applicable. The module also interacts with the controller to facilitate automatic modification of mode of operation, in accordance with an operational decision tree set forth in Table 1; and display of the mode change 1086 so that the water heater may continue to be used until the necessary maintenance or service is provided to overcome the identified failure of a heating source. Next, a failure default screen is displayed, illustrating the temperature of the water in the water storage tank, the mode of operation and that a water system has failed 1088. The failure default screen is displayed continuously until the system is repaired 1090.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system for controlling a heat pump water heater comprising a water storage tank, at least one electric resistance heater configured to heat water within the water storage tank, and a heat pump, the heat pump comprising a working fluid, a compressor, a condenser configured to heat water within the storage tank, an evaporator having an evaporator inlet and an evaporator exit, the system comprising:
an interface for accepting a user input, wherein the interface is configured to:
enable a user to select a system operating mode from a plurality of operating modes, and
display at least one failure condition when a failure condition has been detected;
a first temperature sensor electrically configured to sense the temperature of the water in the storage tank;
an electronic controller operative to implement a plurality of user selectable predetermined operating modes and detect at least one failure condition, and electrically coupled to the interface and to the sensor for controlling operation of the heat pump water heater based on the selected operating mode.

2. The system of claim 1, further comprising:
a second temperature sensor electrically coupled to the electronic controller and configured to indicate an ambient temperature proximate the heat pump water heater,
wherein the electronic controller is configured to:
monitor the ambient temperature during operation of the heat pump,
turn off the heat pump when the ambient temperature falls outside of a preset temperature range, and
activate at least one electric resistance heater to heat the water within the water storage tank.

3. The system of claim 1 further comprising:
at least one additional temperature sensor electrically coupled to the electronic controller and configured to sense an evaporator temperature;
wherein the electronic controller is configured to:
determine a failure condition based on the sensed evaporator temperature:
turn off the heat pump in response to the determination of said failure condition,
activate the at least one electric resistance heater to heat the water, and
activate an indicator on the interface to alert a user of the error condition.

4. The system of claim 1 further comprising:
a second temperature sensor electrically coupled to the electronic controller and configured to sense the evaporator inlet temperature; and
a third temperature sensor electrically coupled to the electronic controller and configured to sense the evaporator exit temperature,
wherein the electronic controller is configured to:
monitor the evaporator inlet temperature and the evaporator exit temperature,
determine at a failure condition based on the sensed evaporator inlet exit temperatures;
turn off the heat pump in response to the determination of said failure condition,
activate the at least one electric resistance heater to heat the water, and
activate an indicator on the interface to alert a user of the error condition.

5. The system of claim 1, wherein the plurality of operating modes comprises at least one of the following: a company mode, a vacation mode, a winter mode, an energy saving mode, a standard electric mode, a high demand mode and a Heat Pump mode.

6. The system of claim 1, wherein the at least one failure condition comprises at least one of the following: a loss of a portion of the working fluid, frost accumulation, an evaporator restriction, a fan malfunction, a compressor malfunction, a sensor error, and a heater fault.

7. The system of claim 6, further comprising:
the electronic controller being further configured to switch to a functional preset mode of operation in response to detection of an error and display an error condition message.

8. The system of claim 1, wherein the electronic controller is located proximate the storage tank and the interface is located a substantial distance from the storage tank.

9. A method for controlling a heat pump water heater comprising a water storage tank, at least one electric resistance heater configured to heat water within the water storage tank, and a heat pump, the heat pump comprising a working fluid, a compressor, a throttling device, a condenser having a condenser inlet and a condenser exit, the condenser configured to heat water within the storage tank, an evaporator having an evaporator inlet and an evaporator exit, a user interface for enabling the user to select from a plurality of operating modes, and at least one temperature sensor, the method comprising:
receiving a user input, representing the selection of an operating mode;
receiving a first temperature indication, the first temperature indication indicating a water temperature of the water in the storage tank; and
interpreting the first temperature indication to activate or deactivate the heat pump and activate or deactivate the at least one electric resistance heater based upon the selected mode of operation.
receiving a second temperature indication, the second temperature indication indicating an evaporator temperature;
determining, based on the evaporator temperatures, the occurrence of a failure condition; and
in response to the occurrence of the failure condition:
(a) turning off the heat pump;
(b) activating the at least one electric resistance heater to heat the water, and
(c) activating an indicator on a user interface to alert a user of the error condition.

10. The method of claim 9, further comprising:
receiving a third temperature indication, the third temperature indication indicating an ambient temperature proximate the heat pump water heater;
monitoring the ambient temperature during operation of the heat pump;
deactivating the heat pump when the ambient temperature falls outside of a preset temperature range; and
activating the at least one electric resistance heater to heat the water.

11. A method for controlling a heat pump water heater comprising a water storage tank, at least one electric resistance heater configured to heat water within the water storage tank, and a heat pump, the heat pump comprising a working fluid, a compressor, a throttling device, a condenser having a condenser inlet and a condenser exit, the condenser configured to heat water within the storage tank, an evaporator having an evaporator inlet and an evaporator exit, a user interface for enabling the user to select from a plurality of operating modes, and at least one temperature sensor, the method comprising:
receiving a user input, representing the selection of an operating mode;
receiving a first temperature indication, the first temperature indication indicating a water temperature of the water in the storage tank; and
interpreting the first temperature indication to activate or deactivate the heat pump and activate or deactivate the at least one electric resistance heater based upon the selected mode of operation;
receiving a second temperature indication indicating an evaporator inlet temperature;
receiving a third temperature indication indicating an evaporator exit temperature;
monitoring a temperature difference between the evaporator inlet temperature and the evaporator exit temperature;
determining, based on the difference between the evaporator inlet temperature and the evaporator exit temperature, the occurrence of an failure condition; and
in response to the occurrence the error condition:
(a) turning off the heat pump;
(b) activating the at least one electric resistance heater to heat the water, and
(c) activating an indicator on a user interface to alert a user of the error condition

12. The method of claim 12, wherein the user selectable operating modes include at least one of the following: a company mode, a vacation mode, a winter mode, an energy saving mode, a standard electric mode, and a heat pump mode.

13. A method for controlling a heat pump water heater comprising a water storage tank, at least one electric resistance heater configured to heat water within the water storage tank, and a heat pump, the heat pump comprising a working fluid, a compressor, a condenser, the condenser configured to heat water within the storage tank, an evaporator having an evaporator inlet and an evaporator exit, a user interface for enabling the user to select from a plurality of operating modes, and a plurality of temperature sensors for sensing a plurality of system temperatures, including one or more of the following temperatures, water temperature in the tank, ambient temperature, evaporator inlet and outlet temperatures and compressor discharge temperature the method comprising:
processing the input from said plurality of temperature sensors to determine at least one failure condition wherein the failure condition comprises at least one of the following: a compressor failure, a temperature sensor failure, and a resistance heater failure.

14. The method of claim 14 wherein the operating mode may be changed to permit the water heater to continue to operate in a mode unaffected by the failure.
